(19) United States
(12) Patent Application Publication
(10) Pub. No.: US 2003/0051962 A1
(43) Pub. Date: Mar. 20, 2003

(54) Force distribution components and spreader components with contactable substantially flat face portions for force transmission

(76) Inventor: Stephen A. Gummow, Rockton, IL (US)

Correspondence Address: PATTI & BRILL, ONE NORTH LASALLE STREET, 44TH FLOOR, CHICAGO, IL, 60602, US

(21) Appl. No.: 10/080,369

(22) Filed: Feb. 21, 2002

Related U.S. Application Data
(63) Continuation-in-part of application No. 09/911,010, filed on Jul. 23, 2001.

(51) Int. Cl. F16D 11/06

(52) U.S. Cl. 192/43

(57) ABSTRACT

Force distribution components of device in one example, upon operative location of the force distribution components relative to one or more force coupler components, are movable among first positions relative to the one or more force coupler components. The force distribution components comprise a force distribution component that comprises one or more substantially flat first face portions. Spreader components of the device are movable among second positions relative to the force distribution components. The spreader components comprise a spreader component that comprises one or more substantially flat second face portions. Location of the spreader components at one or more force transmission position sets of the second positions causes, through employment of contact of one or more of the one or more substantially flat first face portions with one or more of the substantially flat second face portions, location of the force distribution components at one or more force transmission position sets of the first positions.

### CROSS-REFERENCE TO RELATED APPLICATION

This application is a continuation-in-part of commonly-owned U.S. patent application Ser. No. 09/911,010 (by Stephen A. Gummow, filed Jul. 23, 2001, and entitled “FORCE DISTRIBUTION COMPONENTS AND SPREADER COMPONENTS WITH CONTACTABLE SUBSTANTIALLY FLAT FACE PORTIONS FOR FORCE TRANSMISSION”), which is hereby incorporated herein by reference in its entirety.

### TECHNICAL FIELD

The invention in one embodiment relates generally to force transmission and more particularly to transmission of force through contacting of face portions of components.

### BACKGROUND

One example of a device that employs force transmission is a tool such as wrench. One example of a wrench comprises a ratchet wrench. One implementation of a ratchet wrench employs a pawl that serves to transfer force to teeth on a gear wheel of the ratchet wrench by engaging only a relatively small part of the wheel at any one time for transmission of force. As one shortcoming, such an implementation employs an undesirable concentration of force between the pawl and the engaged teeth.

Another implementation of a wrench employs roller bearings. In one design of such a wrench, the roller bearings present a shortcoming of having a tendency to undesirably slip upon application of relatively high torque.

Thus, a need exists for enhanced employment of face portions of components for force transmission. A further need exists for enhanced distribution of force that is transmitted through face portions of components.

### DESCRIPTION OF THE DRAWINGS

Features of exemplary implementations of the invention will become apparent from the description, the claims, and the accompanying drawings in which:

FIG. 1 is a perspective representation of one example of a device that comprises one or more lever components and one or more unit components.

FIG. 2 is a partial perspective representation of another example of the device of FIG. 1.

FIG. 3 is a side sectional representation of one example of a portion of the device of FIG. 1.

FIG. 4 is an end sectional representation of one example of a portion of the device of FIG. 1.

FIG. 5 is a sectional representation of one example of a portion of the device of FIG. 1, illustrating one exemplary position of one example of a plurality of force distribution components, a plurality of spreader components, a first force coupler component, and a plurality of second force coupler components.

FIG. 6 is similar to FIG. 5, and illustrates a second exemplary position.

FIG. 7 is similar to FIG. 5, and illustrates a third exemplary position.

FIG. 8 is a sectional representation of another example of a portion of the device of FIG. 1.

FIG. 9 is a sectional representation of a further example of a portion of the device of FIG. 1.

FIG. 10 is a partial sectional representation of yet another example of a portion of the device of FIG. 1.

FIG. 11 is a partial sectional representation of a still further example of a portion of the device of FIG. 1.

FIG. 12 is a partial sectional representation of an additional example of a portion of the device of FIG. 1.

FIG. 13 is a partial sectional representation of another example of a portion of the device of FIG. 1.

FIG. 14 is a perspective representation of a further example of the device of FIG. 1.

FIG. 15 is a sectional representation of one example of a portion of the device of FIG. illustrating one exemplary position of one example a plunger component and a plurality of detent components.

FIG. 16 is similar to FIG. 15, and illustrates a second exemplary position.

FIG. 17 is similar to FIG. 15, and illustrates a third exemplary position.

FIG. 18 is a perspective representation of another example of the device of FIG. 1, including one or more lever component and one or more unit components.

FIG. 19 is another perspective representation of the device of FIG. 18.

FIG. 20 is an exploded representation of one example of parts that comprise the device of FIG. 18.

FIG. 21 is another exploded representation of the parts of FIG. 18.

FIG. 22 is yet another exploded representation of the parts of FIG. 18.

FIG. 23 is a partial, sectional representation of one example of a portion of the device of FIG. 18, illustrating one exemplary position of one example of a plurality of force distribution components, a plurality of spreader components, and a force coupler component.

FIG. 24 is a partial representation of one example of a portion of the device of FIG. 18, illustrating one exemplary position of one example of a plurality of force distribution components that comprise a plurality of protuberances.

FIG. 25 is a partial, sectional representation of yet another example of a portion of the device of FIG. 18.

FIG. 26 is partial, sectional, side representation of one example of a force coupler component of the device of FIG. 18.

FIG. 27 is a partial, sectional representation of one example of a portion of the device of FIG. 18, illustrating a plurality of force distribution components, a plurality of recesses, and a passage that comprises the four recesses.

FIG. 28 is a partial, sectional representation of one example of a portion of the device of FIG. 18, illustrating a side view of two of a set of four force distribution components.

FIG. 29 is a partial representation of one example of a cap component of the device of FIG. 18.

FIG. 30 is a partial, sectional, side representation of the cap component of FIG. 29.

FIG. 31 is a partial representation of one example of an interface component of the device of FIG. 18.

FIG. 32 is a partial, side representation of the interface component of FIG. 31.

FIG. 33 is a partial representation of one example of a lever component of the device of FIG. 18.

FIG. 34 is a partial, side representation of the lever component of FIG. 33.

FIG. 35 is a sectional representation of one example of a portion of the device of FIG. 18, illustrating one exemplary position of one example of a plurality of force distribution components, a plurality of spreader components, a first force coupler component, and a second force coupler component.

FIG. 36 is similar to FIG. 35, and illustrates a second exemplary position, including a portion of a first detent component.

FIG. 37 is similar to FIG. 35, and illustrates a third exemplary position, including a portion of a second detent component.

FIG. 38 is a partial, sectional, side representation of one example of a portion of the device of FIG. 18, including one or more force distribution components, one or more spreader components, a first force coupler component, a second force coupler component, and a plurality of detent components.

FIG. 39 is a sectional representation of one example of a portion of the device of FIG. 18, illustrating one exemplary position of one example of a plurality of force distribution components, a plurality of spreader components, a first force coupler component, a second force coupler component, and a plurality of detent components.

FIG. 40 is similar to FIG. 39, and illustrates a second exemplary position.

FIG. 41 is similar to FIG. 39, and illustrates a third exemplary position.

FIG. 42 is a partial, sectional representation of a portion of yet another example of the device of FIG. 1 and/or the device of FIG. 18, and illustrates a first exemplary position.

FIG. 43 is similar to FIG. 42 and illustrates a second exemplary position.

FIG. 44. is similar to FIG. 42 and illustrates a third exemplary position

### DETAILED DESCRIPTION

In one embodiment of the invention, substantially flat face portions of force distribution components and spreader components are contactable for force transmission. A detailed discussion of one exemplary embodiment of the invention is presented herein, for illustrative purposes.

Turning to FIG. 1, device 100, in one example, includes a plurality of components such as hardware components. A number of such components can be combined or divided in one example of device 100, as will be appreciated by those skilled in the art.

A portion of a component of device 100 in one example comprises all of the component, and in another example comprises a subportion of the component, where the subportion of the component comprises less than all of the component, as will be appreciated by those skilled in the art.

Referring again to FIG. 1, device 100 in one example comprises tool 102. An exemplary instance of tool 102 comprises wrench 104. Wrench 104 in one example comprises socket wrench 105. In one example, device 100 comprises one or more instances of lever component 106 and one or more instances of unit component 110.

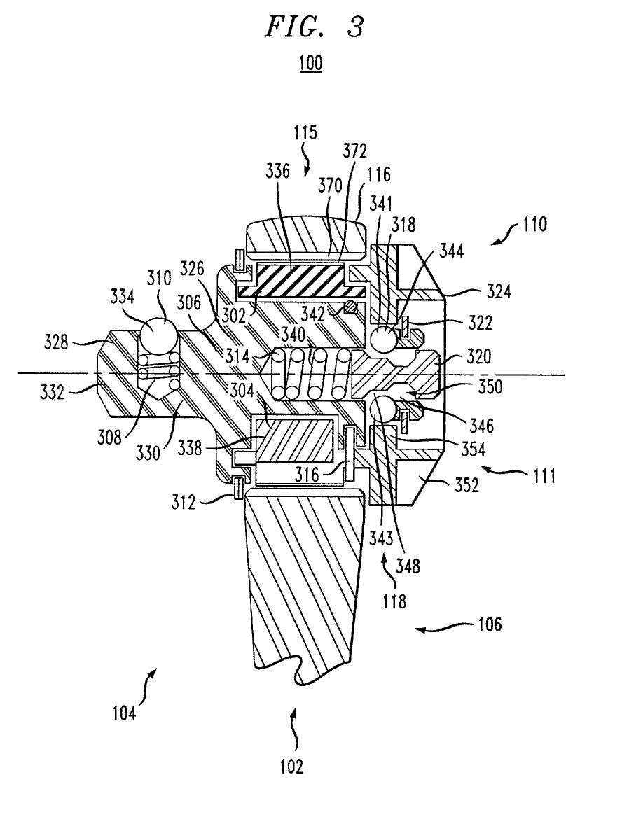

Still referring to FIG. 1, lever component 106 in one example comprises one or more instances of handle component 112, one or more instances of neck component 114, and one or more instances of force coupler component 115. Force coupler component 115 in one example comprises head component 116 and/or one or more instances of protuberance 370 (FIG. 3). Protuberance 370 in one example comprises gear tooth 571 (FIG. 5). One exemplary implementation of handle component 112, neck component 114, and head component 116 is disclosed in U.S. Pat. No. 4,924,737 to Gummow (entitled “Positive Drive Ratchet,” issued May 15, 1990, and assigned to Gummow Tool Company).

In one example, referring to FIG. 1, force coupler component 115 comprises opening 118. Opening 118 in one example serves to receive unit component 110, as described herein. For example, lever component 106 comprises a standard, commercially-available part. A first exemplary ratchet wrench that comprises a lever component and a pawl mechanism drive element (not shown) is offered under the trade identifier “HUSKY 22201 USA” by Husky Professional Tools, 1304 Champion Circle, Carrollton, Tex., 75006, USA. A second exemplary ratchet wrench that comprises a lever component and a pawl mechanism drive element is offered under the trade identifier “SNAP-ON F872” by Snap-on Incorporated, 2801-80^{th} Street, Kenosha, Wis., 53143, USA. In one example, a user employs the lever component of such a (e.g., standard) ratchet wrench as lever component 106, and advantageously substitutes unit component 110 for the pawl mechanism drive element, as will be appreciated by those skilled in the art. For example, unit component 110 is operatively connectable with and/or disconnectable from one or more instances of lever component 106 as a unit, as described herein.

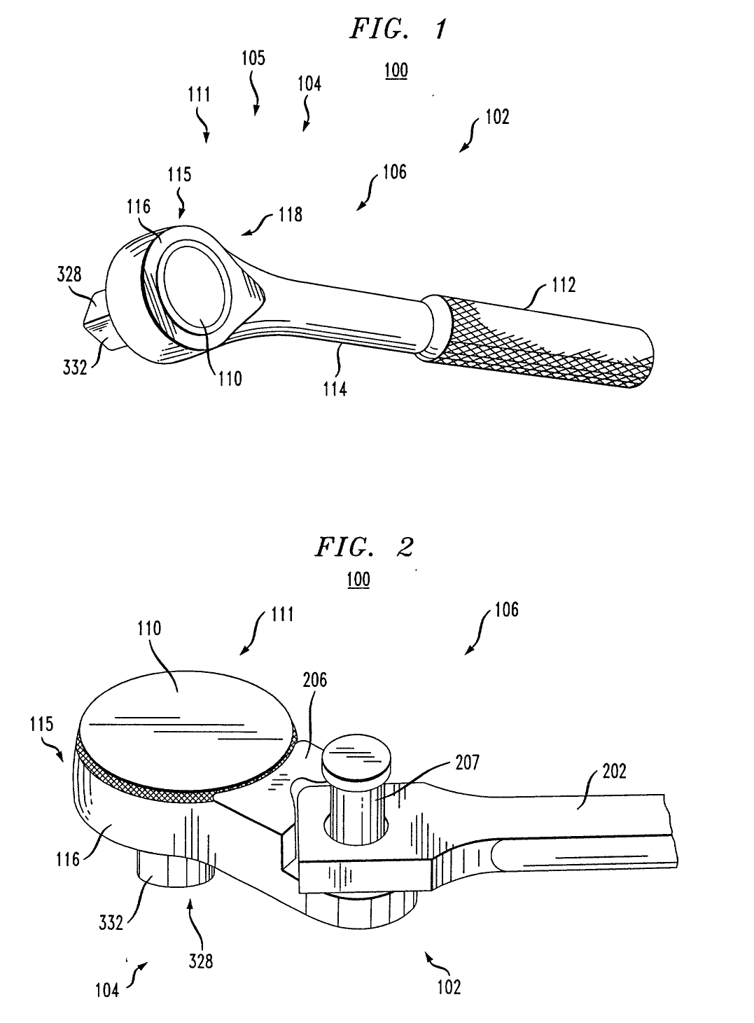

Turning to FIG. 2, in another example, lever component 106 comprises one or more instances of lever component 202 and one or more instances of lever component 206. Lever component 206 in one example is pivotably connectable with lever component 202. In one example, lever component 206 comprises one or more instances of force coupler component 115 and pivot component 207. Pivot component 207 in one example serves to pivotably connect lever components 202 and 206. One exemplary implementation of lever components 202 and 206 is disclosed in U.S. Pat. No. 6,247,386 to Gummow (entitled “Dual Action Indexable Wrench” and issued Jun. 19, 2001). A further exemplary implementation of lever components 202 and 206 is offered under the trade identifiers “HUSKY 24900” and “Indexible Ratchet” by Husky Professional Tools, 1304 Champion Circle, Carrollton, Tex., 75006, USA.

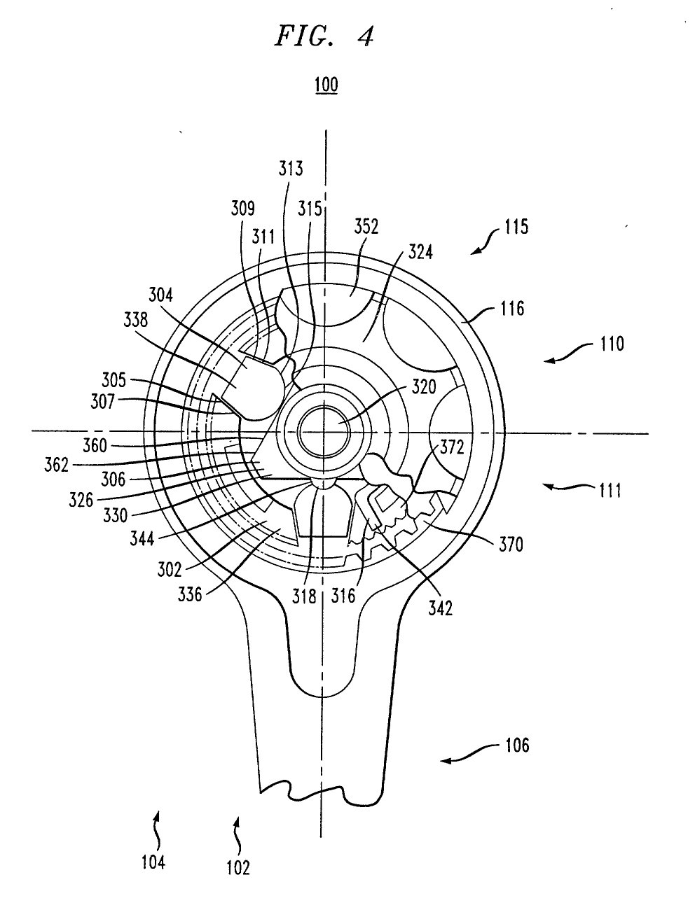

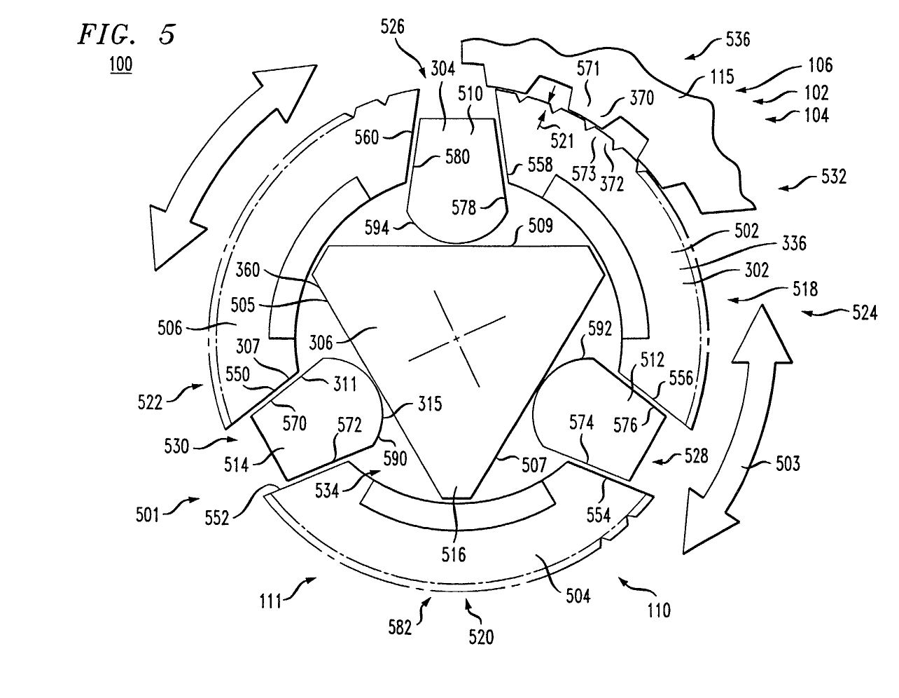

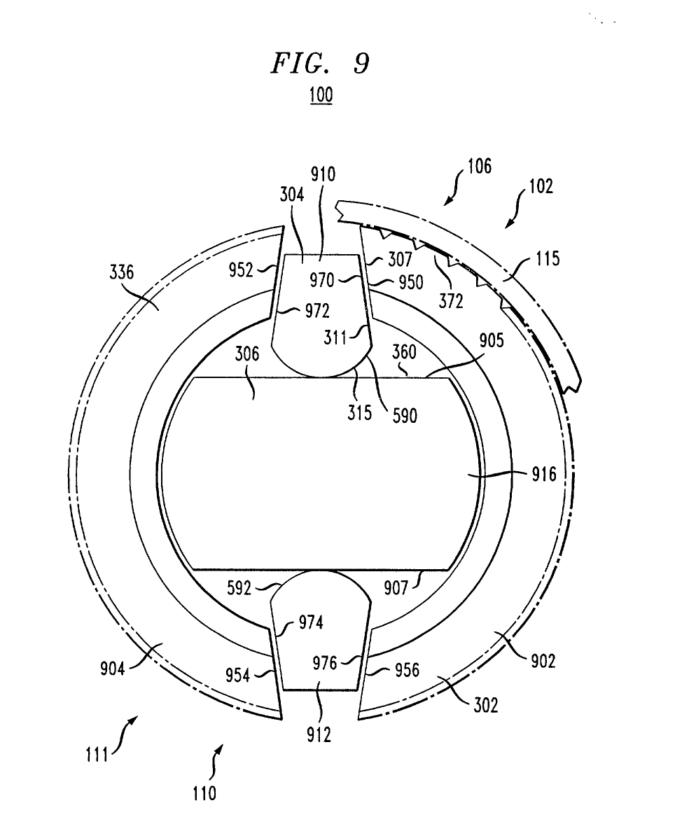

Turning to FIGS. 3-4, unit component 110 in one example comprises one or more instances of force distribution component 302 and one or more instances of spreader component 304. In one example, referring to FIGS. 3-8, unit component 110 comprises three instances of force distribution component 302 and three instances of spreader component 304. In another example, referring to FIG. 9, unit component 110 comprises two instances of force distribution component 302 and two instances of spreader component 304. In a further example, unit component 110 comprises any number of instances of force distribution component 302 and any number of instances of spreader component 304.

Referring further to FIGS. 3-4, unit component 110 in one example comprises one or more of one or more instances of force distribution component 302, one or more instances of spreader component 304, one or more instances of force coupler component 306, one or more instances of spring component 308, one or more instances of detent component 310, one or more instances of snap ring component 312, one or more instances of spring component 314, one or more instances of spring component 316, one or more instances of detent component 318, one or more instances of plunger component 320, one or more instances of snap ring component 322, and one or more instances of cap component 324. In one example, unit component 110 is operatively connectable with and/or disconnectable from one or more instances of force coupler component 115 as a unit.

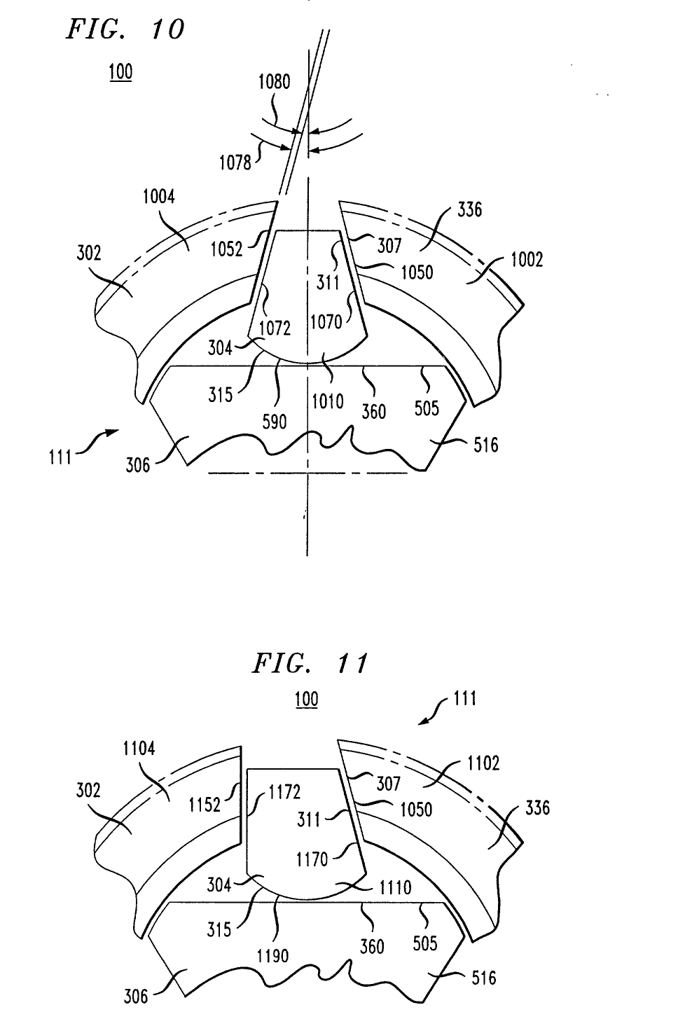

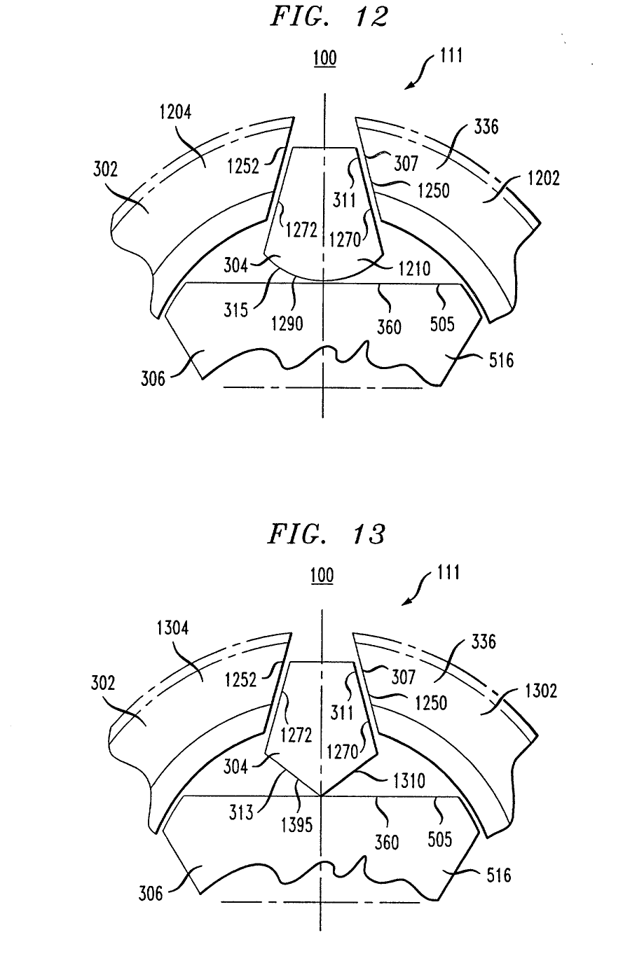

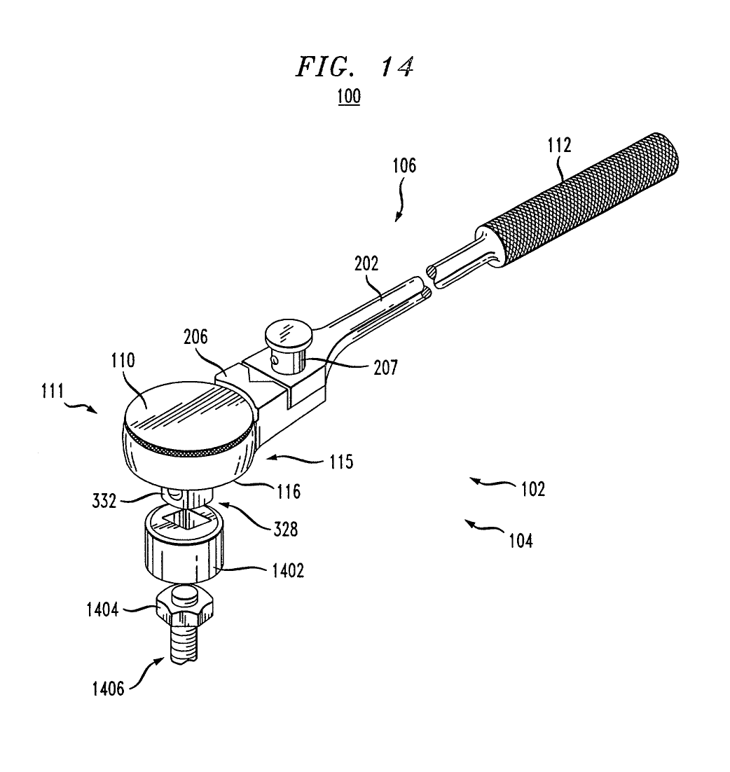

Again referring to FIGS. 3-4, exemplary instances of force distribution component 302 comprise gear shoe component 336 and force distribution components 502 (FIG. 5), 504 (FIG. 5), 506 (FIG. 5), 902 (FIG. 9), 904 (FIG. 9), 1002 (FIG. 10), 1004 (FIG. 10), 1102 (FIG. 11), 1104 (FIG. 11), 1202 (FIG. 12), 1204 (FIG. 12), 1302 (FIG. 13), and 1304 (FIG. 13). Force distribution component 302 in one example comprises one or more instances of face portion 305 and/or one or more instances of protuberance 372. Protuberance 372 in one example comprises dimension 521 (FIG. 5). Dimension 521 in one example comprises a radial depth dimension for protuberance 372 of force distribution component 302. In one example dimension 521 is less than or equal to 0.000102 meters (0.004 inches) and greater than or equal to 0.000305 meters (0.012 inches). For example, dimension 521 is (e.g., approximately) 0.000203 meters (0.008 inches). In a further example, protuberance 372 comprises gear tooth 573 (FIG. 5). Face portion 305 in one example comprises substantially flat face portion 307. Exemplary instances of substantially flat face portion 307 comprise substantially flat face portions 550 (FIG. 5), 552 (FIG. 5), 554 (FIG. 5), 556 (FIG. 5), 558 (FIG. 5), 560 (FIG. 5), 950 (FIG. 9), 952 (FIG. 9), 954 (FIG. 9), 956 (FIG. 9), 1050 (FIG. 10), 1052 (FIG. 10), 1150 (FIG. 11), 1152 (FIG. 11), 1250 (FIG. 12), and 1252 (FIG. 12). Gear shoe component 336 in one example comprises one or more instances of gear tooth 573. In one example, gear shoe component 336 in one example comprises a portion of a continuous or segmented curve, arc, and/or a closed loop. For example, force distribution components 502, 504, and 506 comprise gear shoe 582 (FIG. 5), as will be appreciated by those skilled in the art.

In one example, referring to FIGS. 3-4, substantially flat face portion 307 comprises an entirety of a face of an instance of force distribution component 302. In another example, substantially flat face portion 307 in one example comprises a sub-part of a face of an instance of force distribution component 302. For example, a face of a component comprises one or more sub-parts that comprise an instance of substantially flat face portion 307 and one or more sub-parts that comprise an instance of a non-flat face portion, as will be appreciated by those skilled in the art.

Further referring to FIGS. 3-4, exemplary instances of spreader component 304 comprise wedge component 338 and spreader components 510 (FIG. 5), 512 (FIG. 5), 514 (FIG. 5), 910 (FIG. 9), 912 (FIG. 9), 1010 (FIG. 10), 1110 (FIG. 11), 1210 (FIG. 12), and 1310 (FIG. 13). Wedge component 338 in one example comprises a taper that is directed radially outward from unit component 110. Spreader component 304 in one example comprises one or more instances of face portions 309 and 313. Face portion 309 in one example comprises substantially flat face portion 311. Exemplary instances of substantially flat face portion 311 comprise substantially flat face portions 570 (FIG. 5), 572 (FIG. 5), 574 (FIG. 5), 576 (FIG. 5), 578 (FIG. 5), 580 (FIG. 5), 970 (FIG. 9), 972 (FIG. 9), 974 (FIG. 9), 976 (FIG. 9), 1070 (FIG. 10), 1072 (FIG. 10), 1170 (FIG. 11), 1172 (FIG. 11), 1270 (FIG. 12), and 1272 (FIG. 12).

Now referring to FIGS. 4 and 10, an instance of substantially flat face portion 307 of an instance of force distribution component 302 in one example comprises a shape that is suited to one or more of receive, mate with, and complement a shape of an instance of substantially flat face portion 311 of an instance of spreader component 304 that is intended for (e.g., sliding) contact with the instance of substantially flat face portion 307. For example, corresponding shapes of instances of substantially flat face portions 307 and 311 of an instance of unit component 110 serve, at intended maximal outward radial expansion of gear shoe 582 (FIG. 5), advantageously to stop instances of spreader component 304 short of extending radially further than instances of distribution component 302, for instance, to advantageously promote avoidance of direct force transmission contact between a portion of spreader component 304 and a portion of force coupler component 115, as will be appreciated by those skilled in the art.

Again referring to FIGS. 4 and 10, substantially flat face portion 307 of force distribution component 302 in one example comprises rake 1078. Rake 1078 in one example is less than or equal to forty degrees and greater than or equal to five degrees. For example, rake 1078 is less than or equal to thirty degrees and greater than or equal to eight degrees. In one example, rake 1078 is (e.g., approximately) fifteen degrees. In another example, rake 1078 is (e.g., approximately) ten degrees. Referring to FIG. 10, an instance of force distribution component 302 in one example comprises substantially flat face portions 1050 and 1052 that comprise (e.g., approximately) equal values for rake 1078. Referring to FIG. 11, an instance of force distribution component 302 in one example comprises substantially flat face portions 1150 and 1152 that comprise different values for rake 1078.

Referring still to FIGS. 4 and 10, substantially flat face portion 311 of spreader component 304 in one example comprises rake 1080. Rake 1080 in one example is less than or equal to forty degrees and greater than or equal to five degrees. For example, rake 1080 is less than or equal to thirty degrees and greater than or equal to eight degrees. In one example, rake 1080 is (e.g., approximately) fifteen degrees. In another example, rake 1080 is (e.g., approximately) ten degrees. Referring to FIG. 10, an instance of spreader component 304 in one example comprises substantially flat face portions 1070 and 1072 that comprise (e.g., approximately) equal values for rake 1080. Referring to FIG. 11, an instance of spreader component 304 in one example comprises substantially flat face portions 1170 and 1172 that comprise different values for rake 1080.

In one example, referring to FIGS. 3-4, substantially flat face portion 311 comprises an entirety of a face of an instance of spreader component 304. In another example, substantially flat face portion 311 in one example comprises a sub-part of a face of an instance of spreader component 304. For example, a face of a component comprises one or more sub-parts that comprise an instance of substantially flat face portion 311 and one or more sub-parts that comprise an instance of a non-flat face portion, as will be appreciated by those skilled in the art.

Referring still to FIGS. 3-4, face portion 313 in one example comprises substantially curved face portion 315. Exemplary instances of substantially curved face portion 315 comprise substantially curved face portions 590 (FIG. 5), 592 (FIG. 5), 594 (FIG. 5), 1190 (FIG. 11), and 1290 (FIG. 12). An additional exemplary instance of face portion 313 comprises face portion 1395 (FIG. 13).

An illustrative description of exemplary operation of one or more instances of force distribution component 302 and one or more instances of spreader component 304 is presented herein, for explanatory purposes.

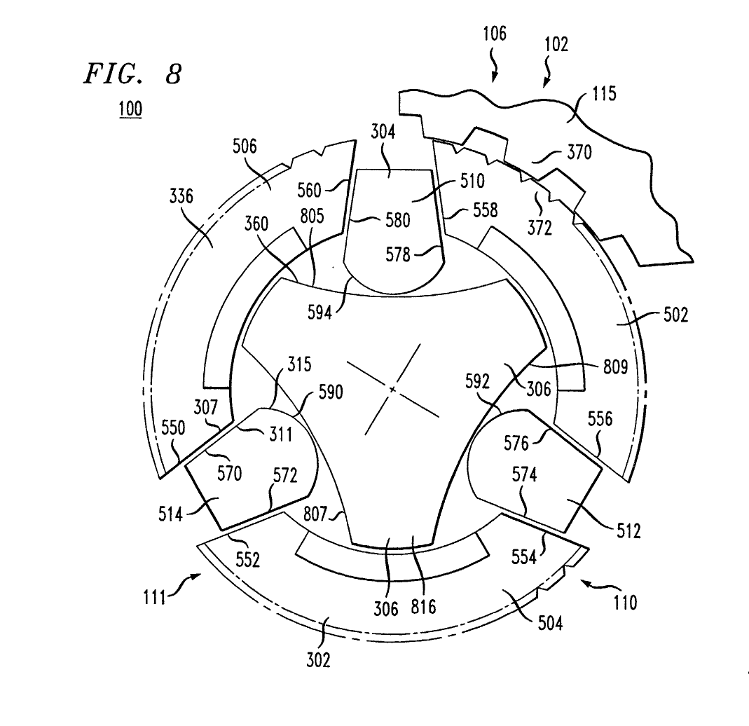

Still referring to FIGS. 3-4, exemplary instances of force coupler component 306 comprise force coupler components 516 (FIG. 5), 816 (FIG. 8), and 916 (FIG. 9). Force coupler component 306 in one example comprises one or more instances of face portion 360. Face portion 360 in one example comprises substantially flat face portion 362. Exemplary instances of face portion 360 comprise substantially flat face portions 505 (FIG. 5), 507 (FIG. 5), and 509 (FIG. 5), substantially curved face portions 805 (FIG. 8), 807 (FIG. 8), and 809 (FIG. 8), and substantially flat face portions 905 (FIG. 9) and 907 (FIG. 9). In a further example, force coupler component 306 comprises central pivot component 326 and drive component 328. Central pivot component 326 in one example comprises center body component 330. Drive component 328 in one example comprises drive tang component 332. In one example, drive component 328 serves to removably engage socket 1402 (FIG. 14). For example, drive component 328 telescopes in the socket. In a further example, drive component 328 transmits force to the socket. For example, drive component 328 serves to transmit rotational force to the socket, for example, for subsequent force transmission to head 1404 (FIG. 14) of bolt 1406 (FIG. 14), as will be appreciated by those skilled in the art.

Further referring to FIGS. 3-4, unit component 110 in one example serves to allow one or more advantageously small instances of finite angular movement 111 between one or more instances of force coupler component 115 and a plurality of instances of force distribution component 304. For example, a plurality of instances of force distribution component 302, a plurality of instances of spreader component 304, and one or more instances of force coupler component 306 in one example serve to allow the one or more instances of finite angular movement 111. In one example, one or more of the one or more instances of finite angular movement 111 is less than or equal to five degrees. In another example, one or more of the one or more instances of finite angular movement 111 is less than or equal to four degrees. In a further example, one or more of the one or more instances of finite angular movement 111 is less than or equal to three degrees. In a still further example, unit component 110 serves to allow a plurality of instances of finite angular movement 111 to be substantially uniform in size, for example, varying by less than one half of a degree.

Referring again to FIGS. 3-4, detent component 310 in one example comprises ball detent component 334. In one example, detent component 310 and spring component 308 serve to present a defined threshold of force for removable engagement of drive component 328 with socket 1402 (FIG. 14). In one example, socket 1402 comprises a recess (not shown) for receiving a portion of detent component 310. In one example, the threshold of removable force insertion presented by detent component 310 upon sliding insertion and removal from the recess of socket 1402 serves to advantageously increase one or more of security, safety, sturdiness, and effective force transmittability in operation of device 100, as will be appreciated by those skilled in the art.

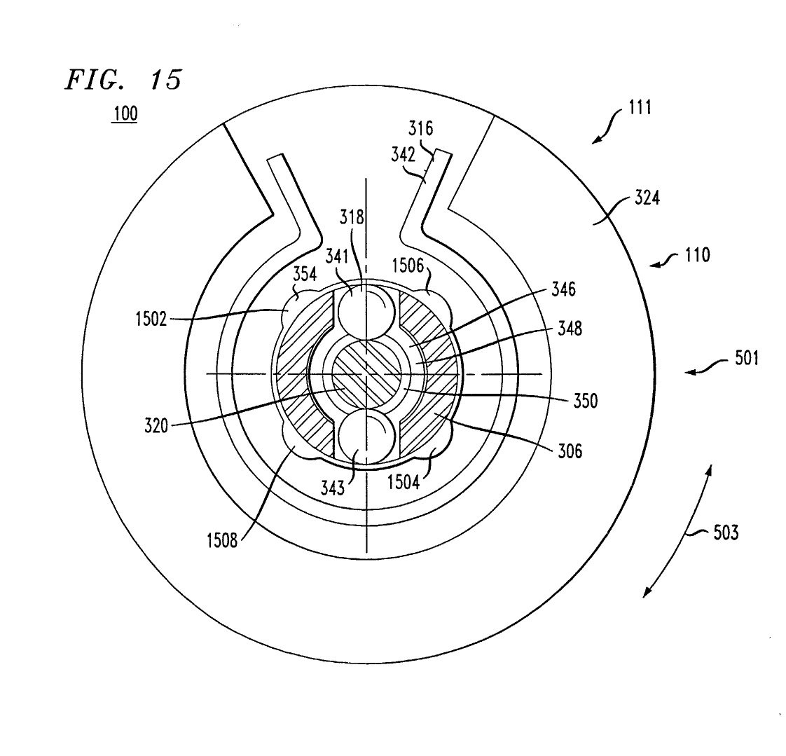

Further referring to FIGS. 3-4, spring component 314 in one example comprises plunger spring component 340. Spring component 316 in one example comprises reversal spring component 342. Detent component 318 in one example comprises ball detent component 344. Exemplary instances of detent component 318 comprise detent components 341 and 343. Plunger component 320 in one example comprises one or more instances of passage 346. Passage 346 in one example comprises a track. Exemplary instances of passage 346 comprise passages 348 and 350. Cap component 324 in one example comprises one or more instances of grip component 352 and one or more instances of recess 354. Grip component 352 in one example comprises one or more of an indentation, a groove, a notch, and a thread. In one example, grip component 352 serves to improve an ability of a user to manipulate cap component 324. Exemplary instances of recess 354 comprise recesses 1502 (FIG. 15), 1504 (FIG. 15), 1506 (FIG. 15), and 1508 (FIG. 15). An illustrative description of exemplary operation of one or more instances of detent component 318, one or more instances of plunger component 320, and one or more instances of cap component 324 is presented herein, for explanatory purposes.

Now is presented an illustrative description of exemplary operation of one or more instances of force distribution component 302, one or more instances of spreader component 304, one or more instances of central pivot component 306, one or more instances of force coupler component 115, one or more instances of detent component 318, one or more instances of plunger component 320, and one or more instances of cap component 324.

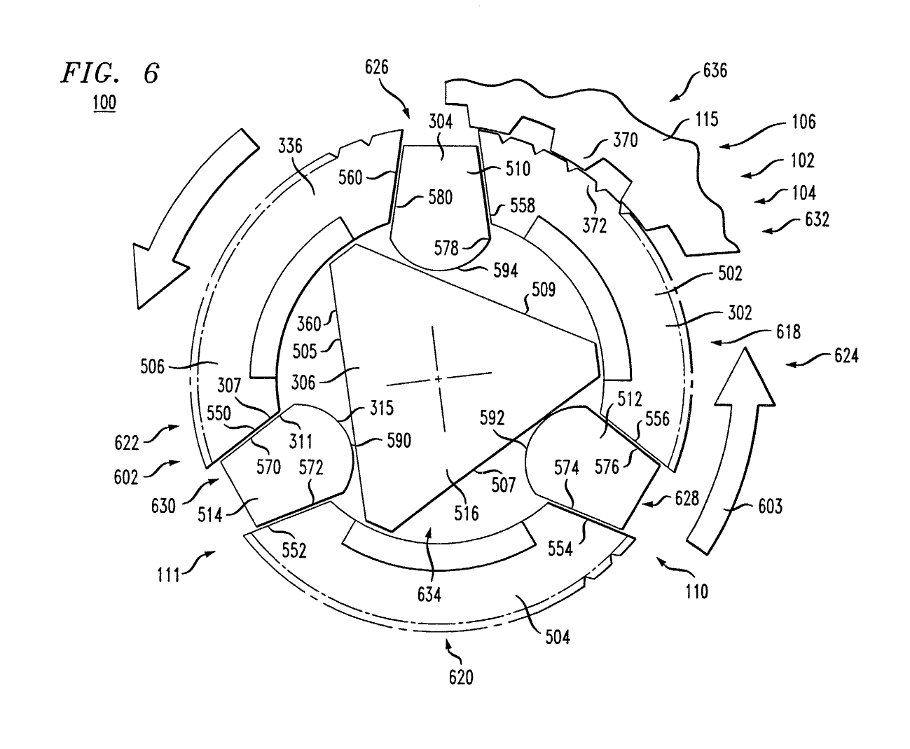

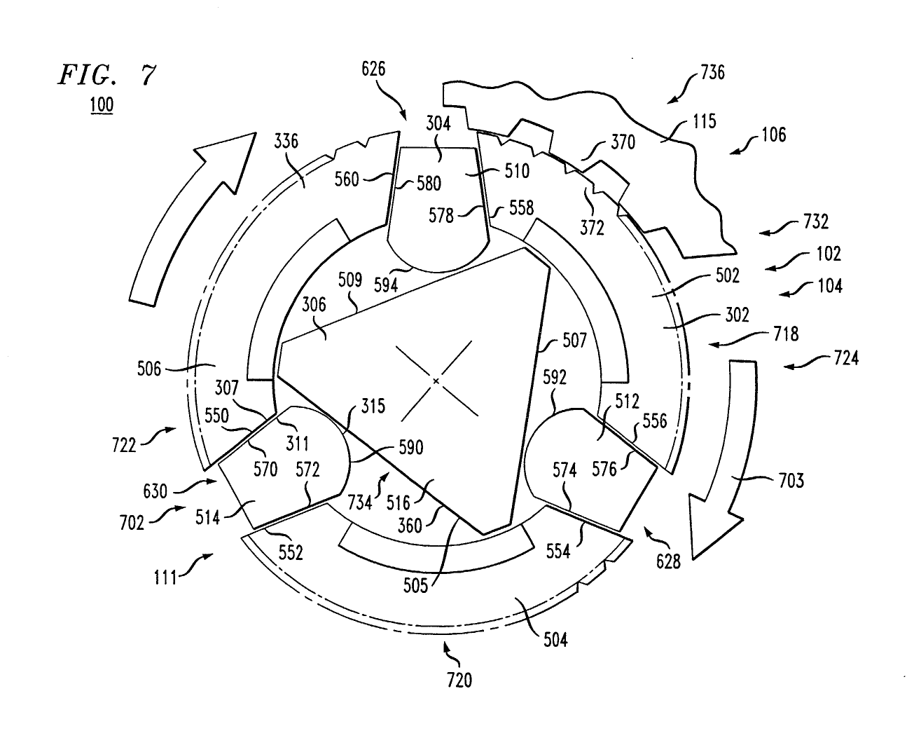

Turning to FIGS. 5 and 15, unit component 110 of device 100 in one example is located at position 501. Position 501 in one example serves as a transitional position between positions 602 (FIG. 6) and 702 (FIG. 7), as described herein. In one example, position 501 comprises a position of neutral (e.g., angular) movement of unit component 110 of device 100. For example, directions 503 are available to unit component 110 at position 501 for angular movement with substantially no force transmission to one or more instances of force coupler component 115, as will be appreciated by those skilled in the art.

Referring now to FIGS. 3 and 15, in one example a user locates unit component 110 at position 501 by pressing plunger component 320 in a direction inward to device that presses plunger component 320 against spring component 314 to compress spring component 314 until exposing and/or introducing passage 350 to detent components 341 and 343, as will be appreciated by those skilled in the art.

Referring to FIG. 5, at position 501 of unit component 110 in one example, force distribution components 502, 504, and 506 are located at positions 518, 520, and 522, respectively. Positions 518, 520, and 522 in one example comprise set 524 of positions for a plurality of instances of force distribution component 302. Spreader components 510, 512, and 514 in one example are located at positions 526, 528, and 530. Positions 526, 528, and 530 in one example comprise set 532 of positions for a plurality of instances of spreader component 304. Sets 524 and 532 of positions in one example comprises positions of relatively unforced fit and/or contact between substantially flat face portions 550, 552, 554, 556, 558, 560 and substantially flat face portions 570, 572, 574, 576, 578, 580, respectively. For example, sets 524 and 532 of positions comprise neutral positions of force distribution component 302 and spreader component 304.

Again referring to FIG. 5, at position 501 of unit component 110, force coupler components 516 and 115 in one example are located at positions 534 and 536, respectively. In one example, position 534 of force coupler component 516 comprises a position of forced contact and/or engagement between force coupler component 516 and socket 1402 (FIG. 14) and/or between force coupler component 516 and spreader components 510, 512, and 514. In another example, position 534 of force coupler component 516 comprises a position of relatively unforced contact and/or engagement between force coupler component 516 and socket 1402 (FIG. 14) and/or between force coupler component 516 and spreader components 510, 512, and 514. Position 536 of force coupler component 115 in one example comprises a position of relative, rotational, substantially non-force transmission between force coupler component 115 and force distribution components 502, 504, and 506. For example, position 536 comprises a neutral position of force coupler component 115.

Referring to FIG. 15, at position 501 of unit component 110 in one example plunger component 320, upon receipt of one or more instances of detent component 318 in one or more instances of passage 346, serves to allow relocation of one or more instances of detent component 318 among one or more instances of recess 354. For example, plunger component 320, upon receipt of detent components 341 and 343 in passage 350, serves to allow relocation of detent components 341 and 343 from recesses 1502 and 1504 to recesses 1506 and 1508, or from recesses 1506 and 1508 to recesses 1502 and 1504. For example, a user moves, pivots, and/or rotates cap component 324 to obtain relocation of detent components 341 and 343 among instances of recess 354, as will be appreciated by those skilled in the art.

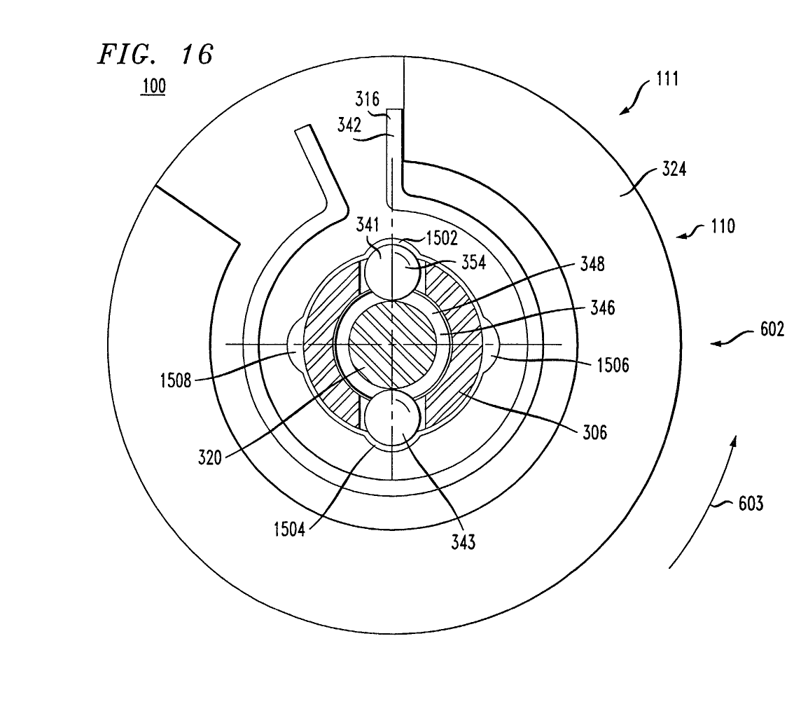

Turning to FIGS. 6 and 16, unit component 110 of device 100 in one example is located at position 602. In one example, position 602 comprises a position of forward and/or counterclockwise angular movement of unit component 110 of device 100. For example, direction 603 is available to unit component 110 at position 602 for angular movement that causes force transmission with one or more instances of force coupler component 115. At position 602 in one example, an angular direction opposite to direction 603 is available to lever component 106 for angular rotation of lever component 106. Device 100 in one example serves to allow one or more instances of finite angular movement 111 of lever component 106 with unit component 110 in direction 603, and/or one or more instances of finite angular movement 111 of lever component 106 without unit component 110 in an angular direction opposite to direction 603, as will be appreciated by those skilled in the art.

Still referring to FIGS. 6 and 16, at position 602 in one example one or more instances of finite angular movement 111 of lever component 106 with unit component 110 in direction 603 serves to abut and/or engage a portion of one or more instances of protuberance 372 with a portion of one or more instances of protuberance 370, for example, to promote force transmission between a plurality of instances of force distribution component 302 and one or more instances of force coupler component 115. In a further example, at position 602 one or more instances of finite angular movement 111 of lever component 106 without unit component 110 in an angular direction opposite to direction 603 serves to contact a portion of one or more instances of protuberance 372 with a portion of one or more instances of protuberance 370, for example, to produce one or more audible sounds, for instance, one or more clicks. One or more of abutment, engagement, and contact of a portion of one or more instances of protuberance 372 with a portion of one or more instances of protuberance 370 at position 602 in one example serves to present to a user of device 100 a sound and/or feel of a ratchet wrench that comprises a lever component and a pawl mechanism drive element (not shown).

Referring to FIG. 6, at position 602 of unit component 110 in one example, force distribution components 502, 504, and 506 are located at positions 618, 620, and 622, respectively. Positions 618, 620, and 622 in one example comprise set 624 of positions for a plurality of instances of force distribution component 302. Spreader components 510, 512, and 514 in one example are located at positions 626, 628, and 630. Positions 626, 628, and 630 in one example comprise set 632 of positions for a plurality of instances of spreader component 304. Sets 624 and 632 of positions in one example comprises positions of relatively forced fit and/or contact between substantially flat face portions 550, 552, 554, 556, 558, 560 and substantially flat face portions 570, 572, 574, 576, 578, 580, respectively. For example, sets 624 and 632 of positions comprise forward and/or counterclockwise torque positions of force distribution component 302 and spreader component 304.

Again referring to FIG. 6, at position 602 of unit component 110, force coupler components 516 and 115 in one example are located at positions 634 and 636, respectively. Position 634 of force coupler component 516 in one example comprises a position of forced contact and/or engagement between force coupler component 516 and socket 1402 (FIG. 14) as well as between force coupler component 516 and spreader components 510, 512, and 514. Position 636 of force coupler component 115 in one example comprises a position of forced contact and/or engagement between force coupler component 115 and force distribution components 502, 504, and 506.

Referring to FIG. 16, at position 602 of unit component 110 in one example cap component 324, upon receipt of one or more instances of detent component 318 in one or more instances of recess 354 and in one or more instances of passage 346, serves to allow force transmission between one or more instances of force coupler component 115 and unit component 110 based on direction 603 of angular rotation of unit component 110. For example, cap component 324, upon receipt of detent components 341 and 343 in recesses 1502 and 1504, respectively, and in passage 348, serves to allow force transmission between one or more instances of force coupler component 115 and unit component 110 based on direction 603 of angular rotation of unit component 110.

At position 602 in one example, referring to FIGS. 6 and 16, angular rotation of force coupler component 516 in direction 603 serves to contact force coupler component 516 with spreader components 510, 512, and 514 and press spreader components 510, 512, and 514 into force distribution components 502, 504, and 506 to press force distribution components 502, 504, and 506 against force coupler component 115 for force transmission to force coupler component 115 in direction 603. Pressing of spreader components 510, 512, and 514 into force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506.

Further referring to FIGS. 6 and 16, at position 602 in another example angular rotation of force coupler component 115 in direction 603 presses force coupler component 115 against force distribution components 502, 504, and 506 to press together force distribution components 502, 504, and 506 and spreader components 510, 512, and 514 while pressing spreader components 510, 512, and 514 against force coupler component 516 for force transmission to force coupler component 516 in direction 603. Pressing together of spreader components 510, 512, and 514 and force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506.

Referring to FIGS. 6 and 10, sliding contact of substantially flat face portions 550, 552, 554, 556, 558, 560 in one example comprises employment of respective instances of rake 1078. In a further example, sliding contact of substantially flat face portions 570, 572, 574, 576, 578, 580 comprises employment of respective instances of rake 1080. In one example, a plurality of instances of rake 1078 and/or 1080 serve to advantageously one or more or distribute, enhance, and increase security of force transmitted from force coupler component 516, through spreader components 510, 512, and 514, through force distribution components 502, 504, and 506, to force coupler component 115. In a further example, a plurality of instances of rake 1078 and/or 1080 serve to advantageously one or more or distribute, enhance, and increase security of force transmitted from force coupler component 115, through force distribution components 502, 504, through spreader components 510, 512, and 514, and 506, to force coupler component 516.

Referring again to FIGS. 6 and 16, contact of force coupler component 516 with spreader components 510, 512, and 514 in one example comprises camming contact of substantially flat face portions 505, 507, and 509 with substantially curved face portions 590, 592, 594, respectively. Camming contact in one example comprises contact among a substantially curved face portion with one or more other face portions, one or more of which in one example are substantially curved, in another example are substantially flat, and in yet another example comprise one or more other shapes, as will be appreciated by those skilled in the art.

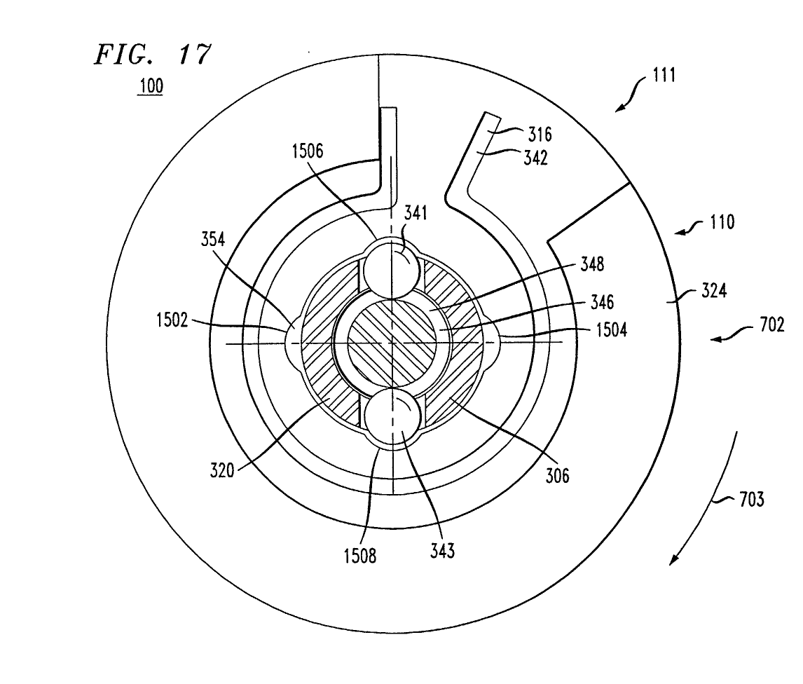

Turning to FIGS. 7 and 17, unit component 110 of device 100 in one example is located at position 702. In one example, position 702 comprises a position of reverse and/or clockwise angular movement of unit component 110 of device 100. For example, direction 703 is available to unit component 110 at position 702 for angular movement that causes force transmission with one or more instances of force coupler component 115. At position 702 in one example, an angular direction opposite to direction 703 is available to lever component 106 for angular rotation of lever component 106. Device 100 in one example serves to allow one or more instances of finite angular movement 111 of lever component 106 with unit component 110 in direction 703, and/or one or more instances of finite angular movement 111 of lever component 106 without unit component 110 in an angular direction opposite to direction 703, as will be appreciated by those skilled in the art.

Still referring to FIGS. 7 and 17, at position 702 in one example one or more instances of finite angular movement 111 of lever component 106 with unit component 110 in direction 703 serves to abut and/or engage a portion of one or more instances of protuberance 372 with a portion of one or more instances of protuberance 370, for example, to promote force transmission between a plurality of instances of force distribution component 302 and one or more instances of force coupler component 115. In a further example, at position 702 one or more instances of finite angular movement 111 of lever component 106 without unit component 110 in an angular direction opposite to direction 703 serves to contact a portion of one or more instances of protuberance 372 with a portion of one or more instances of protuberance 370, for example, to produce one or more audible sounds, for instance, one or more clicks. One or more of abutment, engagement, and contact of a portion of one or more instances of protuberance 372 with a portion of one or more instances of protuberance 370 at position 702 in one example serves to present to a user of device 100 a sound and/or feel of a ratchet wrench that comprises a lever component and a pawl mechanism drive element (not shown).

Referring to FIG. 7, at position 702 of unit component 110, force distribution components 502, 504, and 506 in one example are located at positions 718, 720, and 722, respectively. Positions 718, 720, and 722 in one example comprise set 724 of positions for a plurality of instances of force distribution component 302. Spreader components 510, 512, and 514 in one example are located at positions 726, 728, and 730. Positions 726, 728, and 730 in one example comprise set 732 of positions for a plurality of instances of spreader component 304. Sets 724 and 732 of positions in one example comprises positions of relatively forced fit and/or contact between substantially flat face portions 550, 552, 554, 556, 558, 560 and substantially flat face portions 570, 572, 574, 576, 578, 580, respectively. For example, sets 724 and 732 of positions comprise reverse and/or clockwise torque positions of force distribution component 302 and spreader component 304.

Again referring to FIG. 7, at position 702 of unit component 110, force coupler components 516 and 115 in one example are located at positions 734 and 736, respectively. Position 734 of force coupler component 516 in one example comprises a position of forced contact and/or engagement between force coupler component 516 and socket 1402 (FIG. 14) as well as between force coupler component 516 and spreader components 510, 512, and 514. Position 736 of force coupler component 115 in one example comprises a position of forced contact and/or engagement between force coupler component 115 and force distribution components 502, 504, and 506.

Referring to FIG. 17, at position 702 of unit component 110, cap component 324, upon receipt of one or more instances of detent component 318 in one or more instances of recess 354 and in one or more instances of passage 346, serves to allow force transmission between one or more instances of force coupler component 115 and unit component 110 based on direction 703 of angular rotation of unit component 110. For example, cap component 324, upon receipt of detent components 341 and 343 in recesses 1506 and 1508, respectively, and in passage 348, serves to allow force transmission between one or more instances of force coupler component 115 and unit component 110 based on direction 703 of angular rotation of unit component 110.

At position 702 in one example, referring to FIGS. 7 and 17, angular rotation of force coupler component 516 in direction 703 presses spreader components 510, 512, and 514 into force distribution components 502, 504, and 506 to press force distribution components 502, 504, and 506 against force coupler component 115 for force transmission to force coupler component 115 in direction 703. Pressing of spreader components 510, 512, and 514 into force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506, as will be appreciated by those skilled in the art.

Further referring to FIGS. 7 and 17, at position 702 in another example angular rotation of force coupler component 115 in direction 703 presses force coupler component 115 against force distribution components 502, 504, and 506 to press together force distribution components 502, 504, and 506 and spreader components 510, 512, and 514 while pressing spreader components 510, 512, and 514 against force coupler component 516 for force transmission to force coupler component 516 in direction 703. Pressing together of spreader components 510, 512, and 514 and force distribution components 502, 504, and 506 in one example comprises sliding contact of substantially flat face portions 550, 552, 554, 556, 558, 560 with substantially flat face portions 570, 572, 574, 576, 578, 580, respectively, that in one example results in radially outward movement and compressive contact among spreader components 510, 512, and 514 and force distribution components 502, 504, and 506, as will be appreciated by those skilled in the art.

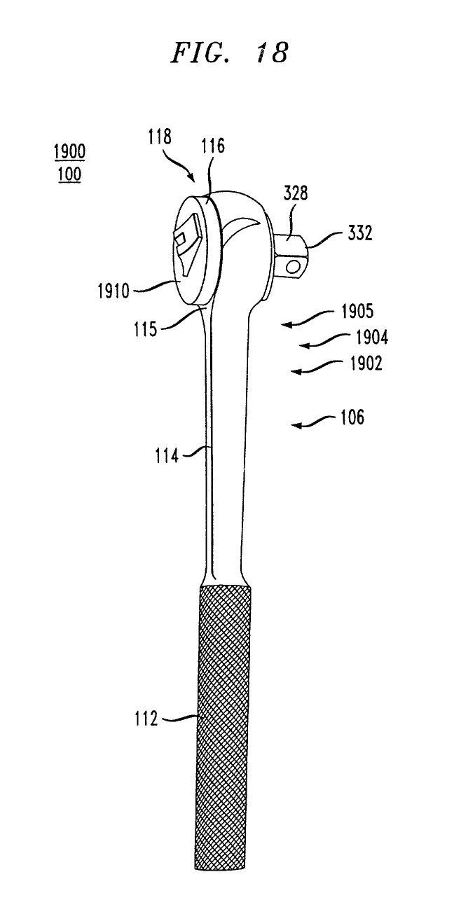

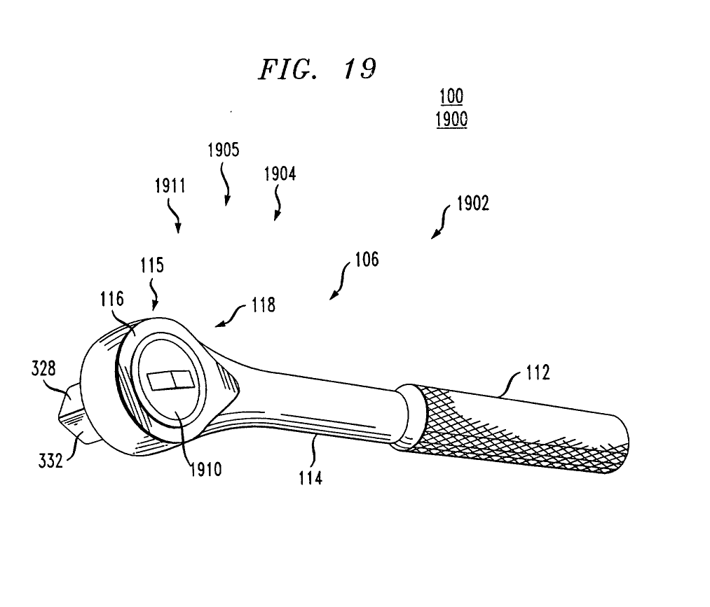

Turning to FIGS. 18-19, in another example, the device 100 comprises a device 1900. The device 1900 in one example comprises a tool 1902. An exemplary instance of the tool 1902 comprises a wrench 1904. The wrench 1904 in one example comprises a socket wrench 1905. In one example, the device 1900 comprises one or more instances of the lever component 106 and one or more instances of the unit component 110, as described herein. In one example, the unit component 110 comprises a unit component 1910.

Still referring to FIG. 19, in one example, the first force coupler component 115 comprises the opening 118. The opening 118 in one example serves to receive the unit component 1910, as described herein. For example, the lever component 106 comprises a standard, commercially-available part.

Again referring to FIG. 19, a first exemplary ratchet wrench that comprises a lever component and a pawl mechanism drive element (not shown) is offered under the trade identifier “HUSKY 22201 USA” by Husky Professional Tools, 1304 Champion Circle, Carrollton, Tex., 75006, USA. A second exemplary ratchet wrench that comprises a lever component and a pawl mechanism drive element is offered under the trade identifier “SNAP-ON F872” by Snap-on Incorporated, 2801-80^{th} Street, Kenosha, Wis., 53143, USA. A third exemplary ratchet wrench that comprises a lever component and a pawl mechanism drive element is offered under the trade identifier “STANLEY 85-483T ⅜″(inch) Round Head Ratchet” by The Stanley Works, 1000 Stanley Drive, New Britain, Conn. 06053, USA. A fourth exemplary ratchet wrench that comprises a lever component and a pawl mechanism drive element is offered under the trade identifier “STANLEY 85-481T ¼″(inch) Round Head Ratchet” by The Stanley Works, 1000 Stanley Drive, New Britain, Conn. 06053, USA. A fifth exemplary ratchet wrench that comprises a lever component and a pawl mechanism drive element is offered under the trade identifier “STANLEY 85-486T ½″(inch) Round Head Ratchet” by The Stanley Works, 1000 Stanley Drive, New Britain, Conn. 06053, USA. In one example, a user employs the lever component of such a (e.g., standard) ratchet wrench as the lever component 106, and advantageously substitutes the unit component 1910 for the pawl mechanism drive element, as will be appreciated by those skilled in the art. For example, the unit component 1910 is operatively connectable with and/or disconnectable from one or more instances of the lever component 106 as a unit, as described herein.

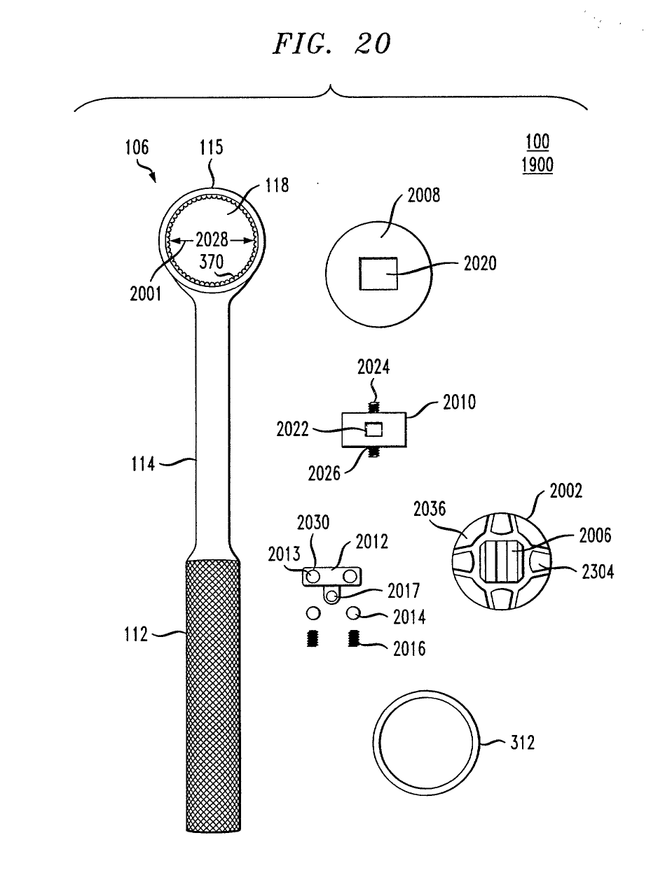

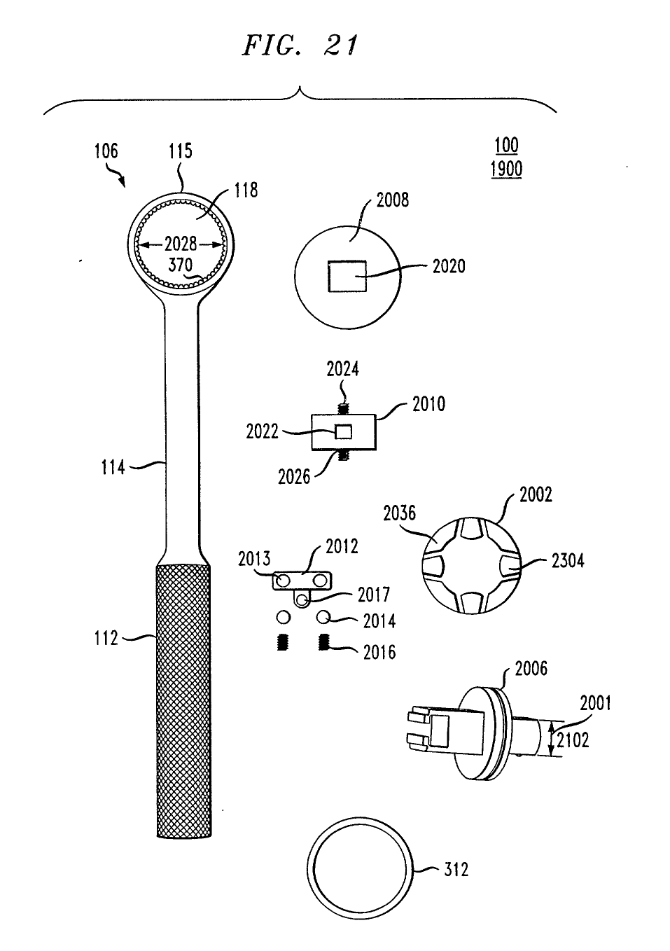

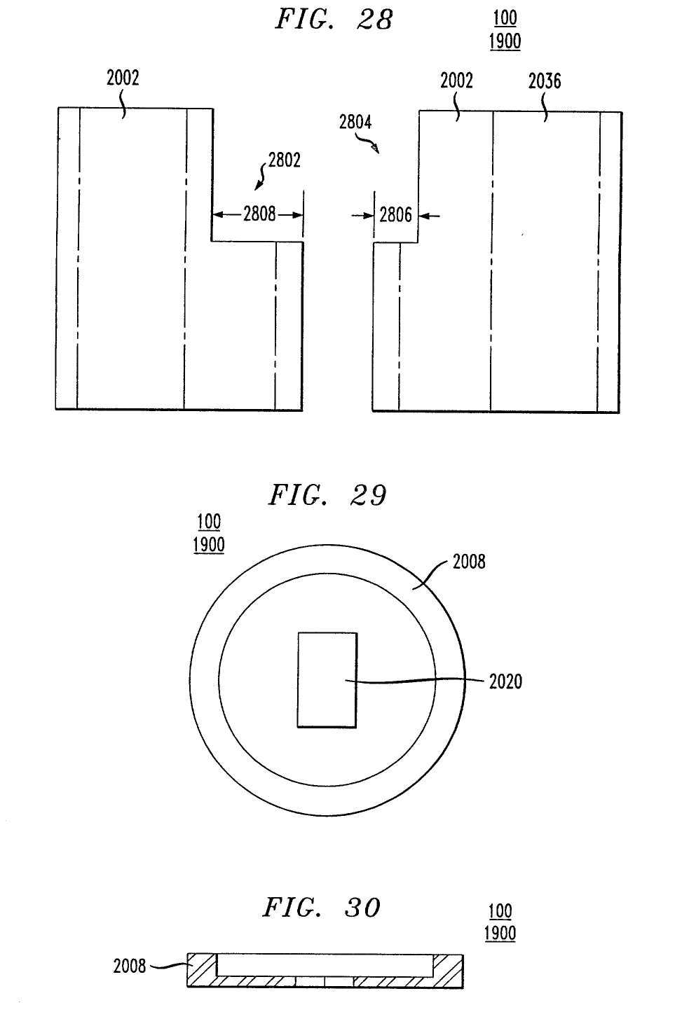

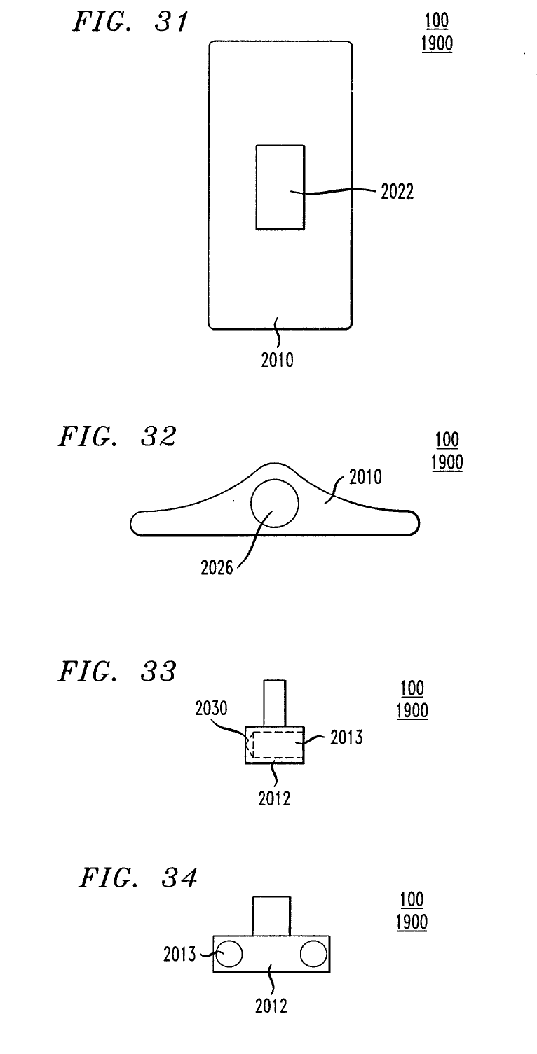

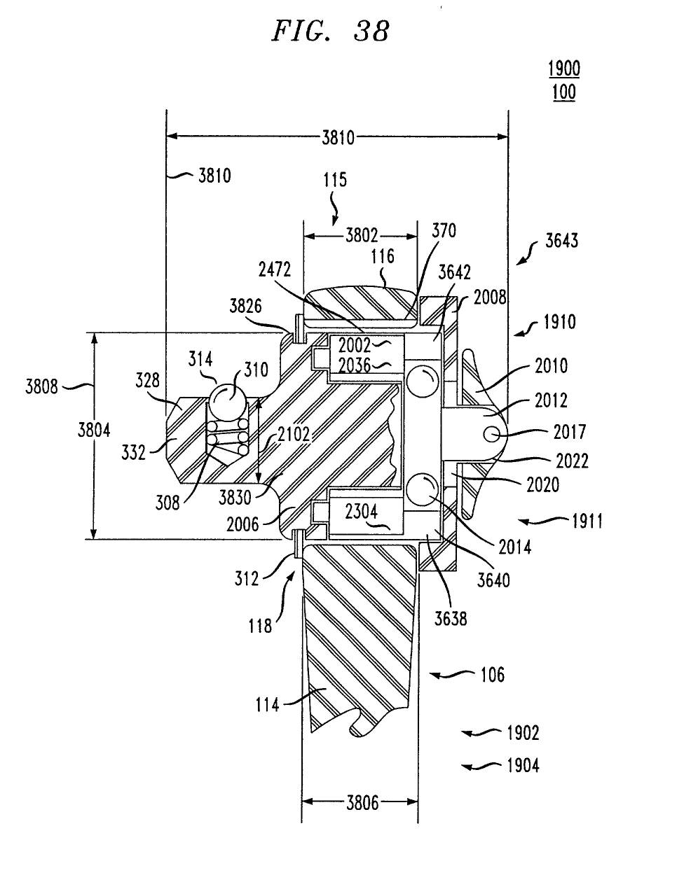

Turning to FIG. 20, the device 1900 in one example comprises one or more instances of a dimension 2001. Exemplary instances of the dimension 2001 comprise diameter dimensions 2028, 2102 (FIG. 21), 2421 (FIG. 24), 2102 (FIG. 26), 2808 (FIG. 28), and 2806(FIG. 28), and depth dimension 3802 (FIG. 38), outer diameter dimension 3804 (FIG. 38), and unit depth dimension 3806 (FIG. 38). The dimensions 2001 in one example represent measurements of the device 1900. In one example, the dimension 2001 is a measure of a diameter 2028 of the opening 118 as described herein. In another example, the dimension 2001 comprises a major dimension 3808 of the unit component 1910. The major dimension 3808 in one example comprises the outer dimension 3804.

Referring to FIGS. 20-21, in one example, the opening 118 is substantially circular. The opening 118 in one example comprises a plurality of the diameter dimension 2028. In one example, the diameter dimension 2028 is proportionate to the dimension 2102. In another example, where the dimension 2102 is approximately 0.00953 meters (“⅜” or 0.375 inches), the diameter dimension 2028 is less than or equal to 0.03175 meters (“1¼” or 1.25 inches) and greater than or equal to 0.01905 meters (“¾” or 0.75 inches). For example, the opening 118 comprises the diameter dimension 2028 of approximately 0.0254 meters (“1” or 1.00 inches). In yet another example, where the dimension 2102 is 0.00635 meters (“¼” or 0.250 inches), the diameter dimension 2028 is less than or equal to 0.01905 meters (“¾” or 0.75 inches) and greater than or equal to 0.01270 meters (“½” or 0.50 inches). For example, the diameter dimension 2028 is approximately 0.01600 meters (“⅝” or 0.63 inches). In a further example, where the dimension 2102 is approximately 0.01270 meters (“½” or 0.50 inches), the diameter dimension 2028 is less than or equal to 0.03810 meters (“1½” or 1.50 inches) and greater than or equal to 0.03175 meters (“1¼” or 1.25 inches). For example, the diameter dimension 2028 is approximately 0.03505 meters (“1⅜” or 1.38 inches). In yet a further example, where the dimension 2102 is 0.01905 meters (“¾” or 0.75 inches), the diameter dimension 2028 is less than or equal to 0.07630 meters (“3” or 3.00 inches) and greater than or equal to 0.06350 meters (“2½” or 2.50 inches). For example, the diameter dimension 2028 is approximately 0.06985 meters(“2¾” or 2.75 inches).

Turning to FIG. 38, the opening 118 comprises a plurality of a depth dimensions 3802. In one example, the depth dimension 3802 is proportionate to the dimension 2102. In another example, the dimension 2102 is approximately 0.00953 meters (“⅜” or 0.38 inches) and the depth dimension 3802 is less than or equal to 0.01905 meters (“¾” or 0.75 inches) and greater than or equal to 0.01270 meters (“½” or 0.50 inches). For example, the depth dimension 3802 is approximately 0.01588 meters (“⅝” or 0.63 inches). In yet another example, the dimension 2102 is approximately 0.00635 meters (“¼” or 0.25 inches) and the depth dimension 3802 is less than or equal to 0.00953 meters (“⅜” or 0.38 inches) and greater than or equal to 0.00794 meters (“5/16” or 0.31 inches). For example, the depth dimension 3802 is approximately 0.00873 meters(“11/32” or 0.34 inches). In still another example, the dimension 2102 is approximately 0.0127 meters (“½” or 0.50 inches) and the depth dimension 3802 is less than or equal to 0.0254 meters (“1” or 1.00 inches) and greater than or equal to 0.01905 meters (“¾” or 0.75 inches). For example, the depth dimension 3802 is approximately 0.02222 meters(“⅞” or 0.88 inches). In a further example, the dimension 2102 is approximately 0.01905 meters (“¾” or 0.75 inches) and the depth dimension 3802 is less than or equal to 0.03810 meters (“1½” or 1.5 inches) and greater than or equal to 0.02540 meters (“1” or 1.00 inches). For example, the depth dimension 3802 is approximately 0.03175 meters(“1¼” or 1.25 inches).

Again referring to FIG. 38, the unit component 1910 comprises four force distribution components 2002, four spreader components 2304, a second force coupler component 2006, a cap component 2008, an interface component 2010, a snap ring component 312, a lever component 2012, one or more spring components 2016, and one or more detent components 2014. The unit component 1910 comprises the outer diameter dimension 3804. In one example, the outer diameter dimension 3804 is (e.g. slightly) less than the diameter dimension 2028. In another example, the outer diameter dimension 3804 and the diameter dimension 2028 are of substantially the same size. For example, the dimension 3804 is such that the unit component 1910 can fit in the opening 118. The unit component 1910 comprises the unit depth dimension 3806. In one example, the unit depth dimension 3806 and the depth dimension 3802 are of substantially the same length. In another example, the unit depth dimension 3806 allows the unit component 1910 to fit in the opening 118.

Still referring to FIG. 38, the unit component 1910 comprises a dimension 3810. The dimension 3810 in one example represents a measure of the depth of unit component 1910. In one example, the dimension 3810 is greater than the dimension 3802. For example, the unit component 1910 partially fits within the opening 118 in the dimension 3810.

Still referring to FIG. 38, the four force distribution components 2002, the four spreader components 2304, and the second force coupler component 2006 serve to promote the strength of the unit component 1910 and/or the device 1900. In one example, the four force distribution components 2002, the four spreader components 2304, and the second force coupler component 2006 serve to promote sharing of a load transmitted in and/or through the unit component 1910 and/or the device 1900. In another example, the four force distribution components 2002, the four spreader components 2304, and the second force coupler component 2006 serve to promote one or more of security, safety, sturdiness, and effective force transmittability in operation of the unit component 1910 and/or the device 1900, as will be appreciated by those skilled in the art.

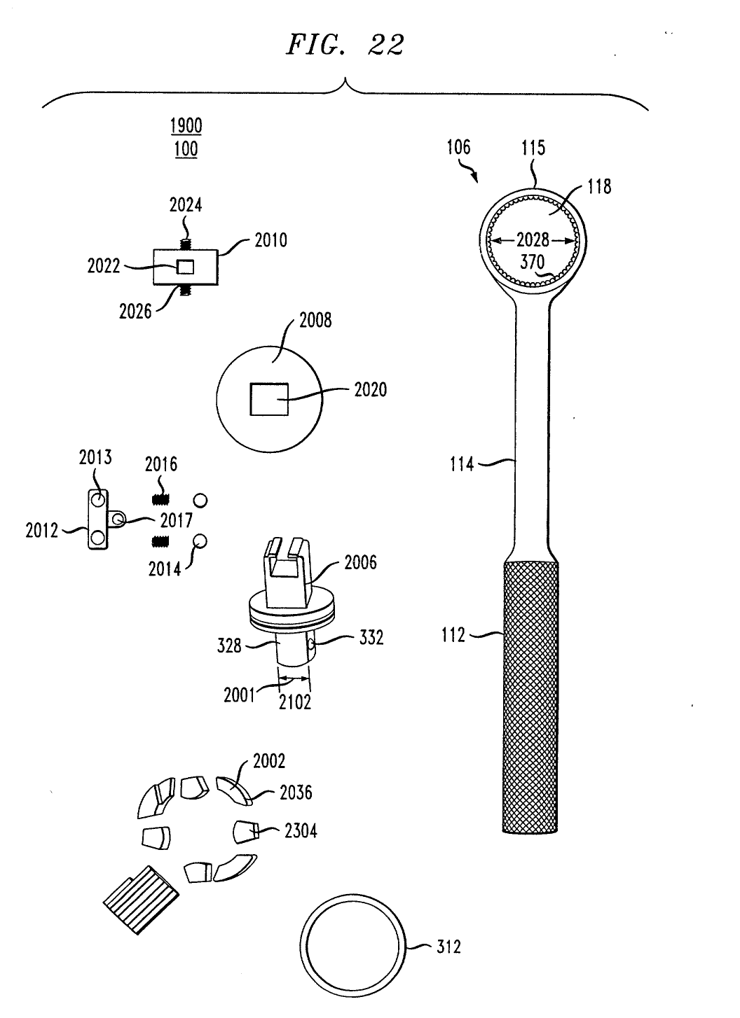

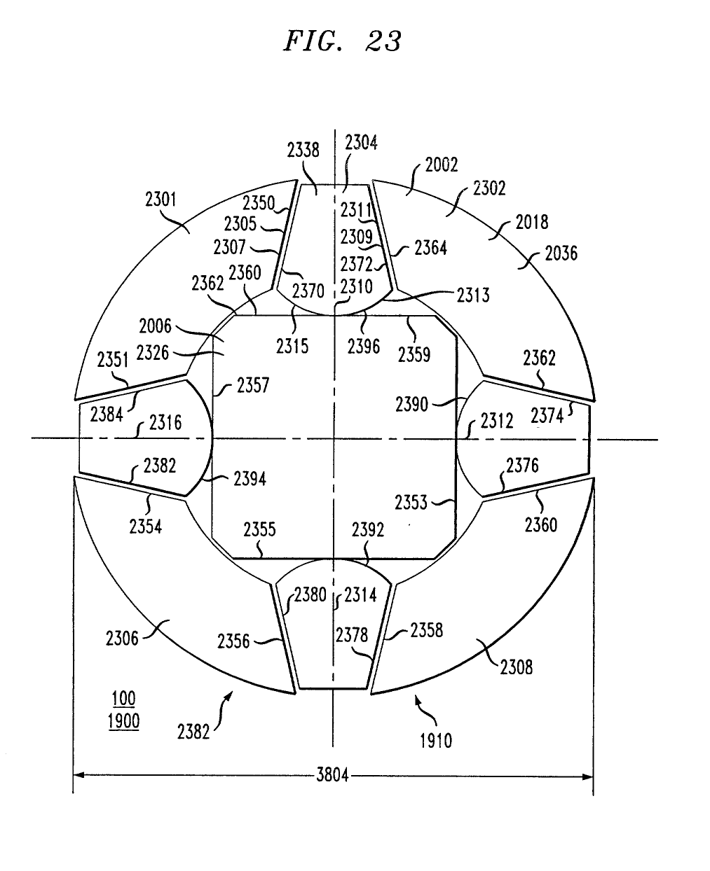

Turning to FIGS. 23-24, the force distribution component 336 in one example comprises the force distribution component 2002. Exemplary instances of the force distribution component 2002 comprise gear shoe component 2036 and force distribution components 2301, 2302, 2306, and 2308. Force distribution component 2002 in one example comprises two instances of face portion 2305 and/or one or more instances of protuberance 2472. Protuberance 2472 in one example comprises dimension 2421. Dimension 2421 in one example comprises a radial depth dimension for protuberance 2472 of force distribution component 2002. In one example dimension 2421 is less than or equal to 0.0001902 meters (0.004 inches) and greater than or equal to 0.0002305 meters (0.012 inches). For example, dimension 2421 is (e.g., approximately) 0.000254 meters (0.010 inches). In a further example, protuberance 2472 comprises gear tooth 2473. Face portion 2305 in one example comprises substantially flat face portion 2307. Exemplary instances of substantially flat face portion 2307 comprise substantially flat face portions 2350, 2352, 2354, 2356, 2358, 2360, 2362, and 2364. Gear shoe component 2036 in one example comprises one or more instances of gear tooth 2473. In one example, gear shoe component 2036 comprises a portion of a continuous or segmented curve, arc, and/or a closed loop. For example, force distribution components 2301, 2302, 2306, and 2308 comprise gear shoe 2382, as will be appreciated by those skilled in the art.

Referring again to FIG. 23, in one example, substantially flat face portion 2307 comprises an entirety of a face of an instance of force distribution component 2002. In another example, substantially flat face portion 2307 in one example comprises a sub-part of a face of an instance of force distribution component 2002. For example, a face of a component comprises one or more sub-parts that comprise an instance of substantially flat face portion 2307 and one or more sub-parts that comprise an instance of a non-flat face portion, as will be appreciated by those skilled in the art. In one example, force distribution component

Further referring to FIG. 23, the spreader component 304 in one example comprises the spreader component 2304. Exemplary instances of spreader component 2304 comprise wedge component 2338 and spreader components 2310, 2312, 2314, and 2316. Wedge component 2338 in one example comprises a taper that is directed radially outward from unit component 1910. The spreader component 2304 in one example comprises two instances of face portions 2309 and 2313. Face portion 2309 in one example comprises substantially flat face portion 2311. Exemplary instances of substantially flat face portion 2311 comprise substantially flat face 2370, 2372, 2374, 2376, 2378, 2380, 2382, and 2384.

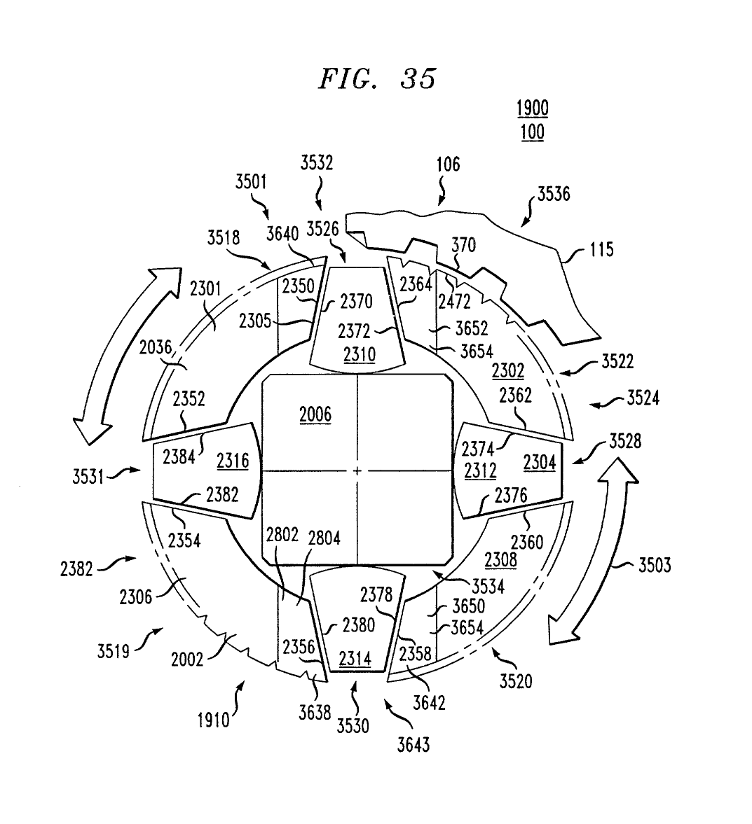

Turning to FIG. 35, an instance of substantially flat face portion 2307 of an instance of force distribution component 2002 in one example comprises a shape that is suited to one or more of receive, mate with, and complement a shape of an instance of substantially flat face portion 2311 of an instance of spreader component 2304 that is intended for (e.g., sliding) contact with the instance of substantially flat face portion 2307. For example, corresponding shapes of instances of substantially flat face portions 2307 and 2311 of an instance of unit component 1910 serve, at intended maximal outward radial expansion of gear shoe 2382, advantageously to stop instances of spreader component 2304 short of extending radially further than instances of force distribution component 2002, for instance, to advantageously promote avoidance of direct force transmission contact between a portion of spreader component 2304 and a portion of the first force coupler component 115, as will be appreciated by those skilled in the art.

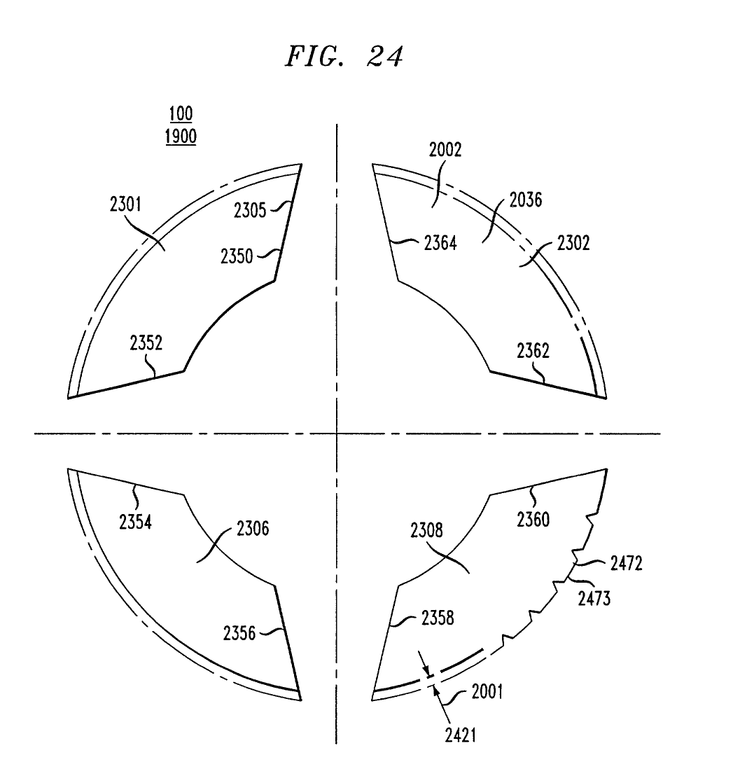

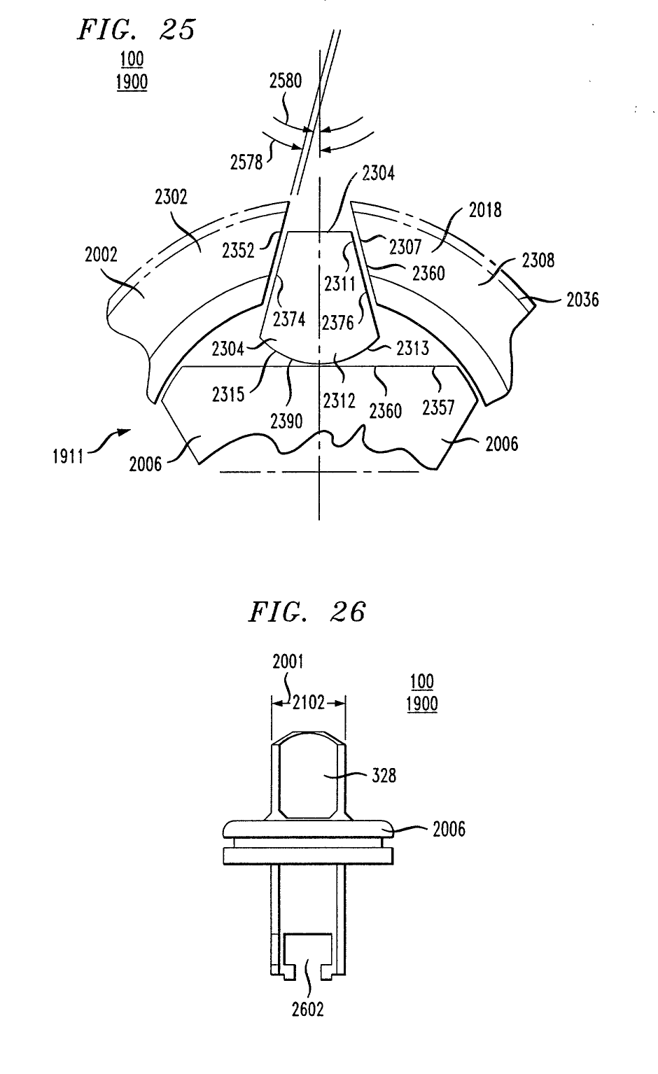

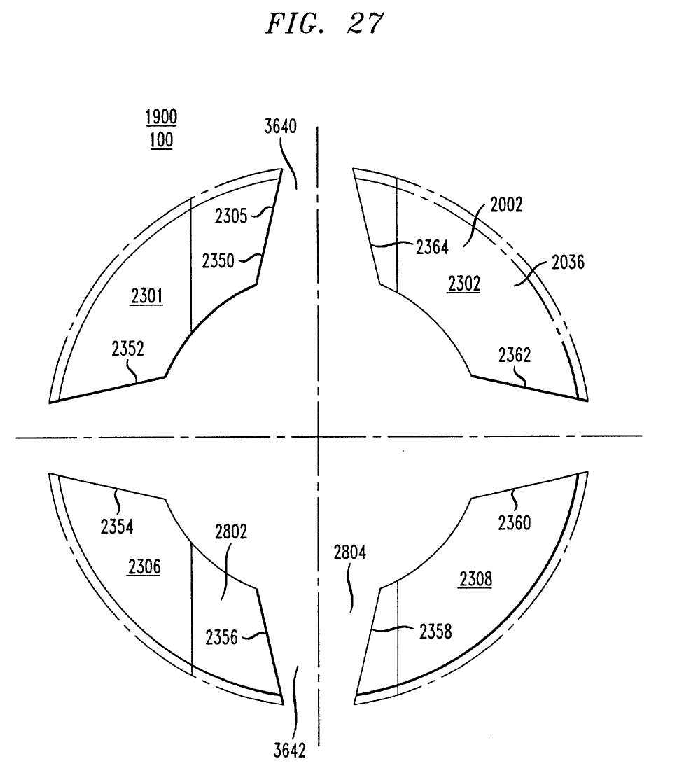

Referring to FIGS. 23 and 25, substantially flat face portion 2307 of force distribution component 2002 in one example comprises rake 2578. Rake 2578 in one example is less than or equal to forty degrees and greater than or equal to five degrees. For example, rake 2578 is less than or equal to thirty degrees and greater than or equal to eight degrees. In one example, rake 2578 is (e.g., approximately) twelve degrees. In one example, an instance of force distribution component 2002 in one example comprises substantially flat face portions 2360 and 2362 that comprise (e.g., approximately) equal values for rake 2578.

Referring still to FIGS. 23 and 25, substantially flat face portion 2311 of spreader component 2304 in one example comprises rake 2580. Rake 2580 in one example is less than or equal to forty degrees and greater than or equal to five degrees. For example, rake 2580 is less than or equal to thirty degrees and greater than or equal to eight degrees. In one example, rake 2580 is (e.g., approximately) twelve degrees. An instance of spreader component 2304 in one example comprises substantially flat face portions 2376 and 2374 that comprise (e.g., approximately) equal values for rake 2580.

Referring to FIG. 23, in one example, substantially flat face portion 2311 comprises an entirety of a face of an instance of spreader component 2304. In another example, substantially flat face portion 2311 in one example comprises a sub-part of a face of an instance of spreader component 2304. For example, a face of a component comprises one or more sub-parts that comprise an instance of substantially flat face portion 2311 and one or more sub-parts that comprise an instance of a non-flat face portion, as will be appreciated by those skilled in the art.

Referring still to FIG. 23, face portion 2313 in one example comprises substantially curved face portion 2315. Exemplary instances of substantially curved face portion 2315 comprise substantially curved face portions 2390, 2392, 2394, and 2396.

Referring to FIG. 20, the lever component 2012 in one example comprises two spring passages 2013. In one example, the lever component 2012 comprises two spring components 2016 and two detent components 2014. The spring passages 2013 in one example serve to receive the detent components 2014 and spring components 2016.

Referring to FIGS. 20 and 33, in one example one end of the one of the one or more spring components 2016 abuts a base 2030 of the lever component 2012 in one of the two spring passages 2013 and the other end of the one of the one or more spring components 2016 abuts the one of the one or more detent components 2014. For example, one of the one or more spring components 2016 serves to create a tension that extends the one of the one or more detent components 2014 outward from the one of the one or more spring passages 2013.

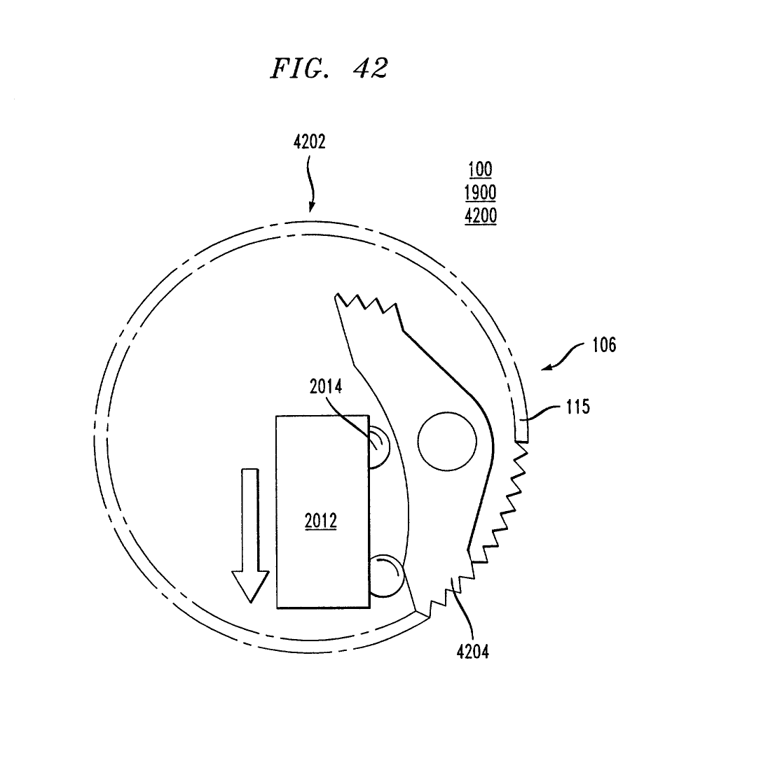

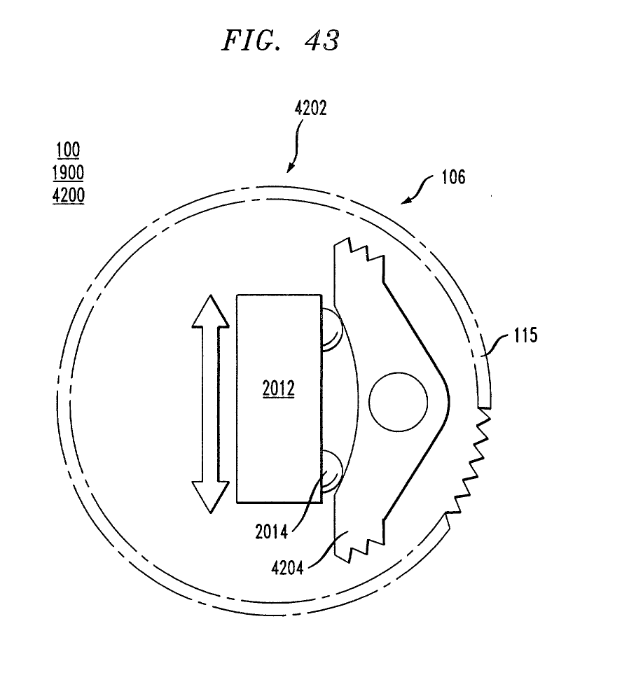

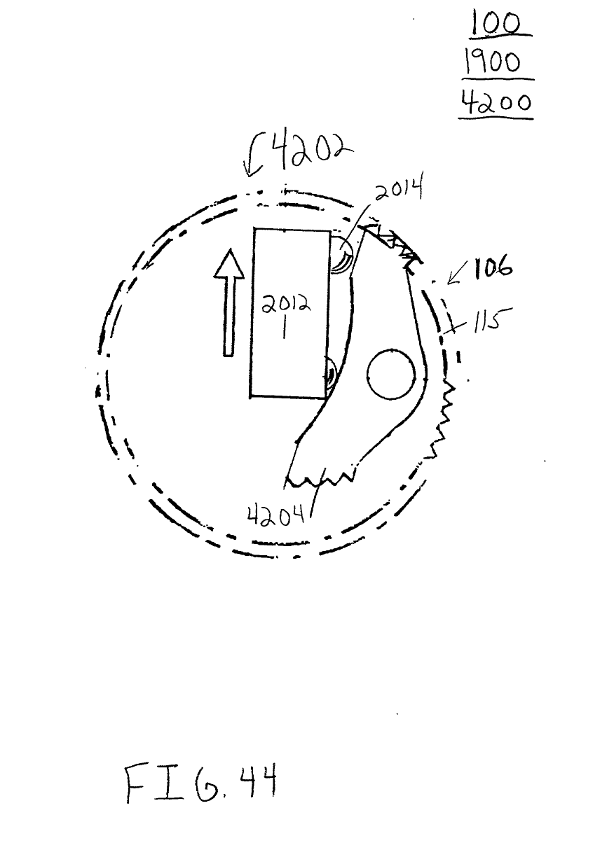

Referring to FIGS. 38 and 42-44, in one example, the lever component 2012, the one or more spring components 2016, and the one or more detent components 2014 serve to control the force transmission of the device 1900, as described herein. A further example of devices 100 and 1900 comprise a device 4200. The device 4200 in one example comprises a tool 4202. In another example, the tool 4202 comprises a pawl driven gear ratchet 4204. For example, the lever component 2012, the one or more spring components 2016, and the one or more detent components 2014 are employable with the pawl driven gear ratchet 4204 to control the angular direction of force transmission for the tool 4202.

Referring to FIGS. 20 and 38, the cap component 2008 in one example comprises a recess 2020. The recess 2020 serves to allow a portion of the lever component 2012 to extend through the cap component 2008. In one example, the recess 2020 allows a portion of the lever component 2012 to pass through the cap component 2008. The lever component 2012 comprises one or more of an attachment recess 2017. In one example, the lever component 2012 contains one of the attachment recesses 2017. In another example, the lever component 2012 contains two of the attachment recesses 2017.

Still referring to FIGS. 20 and 38, the interface component 2010 in one example comprises a recess 2022 and one or more attachment components 2024. In one example, the attachment component 2024 is a screw. In another example, the attachment component 2024 is a pin. The recess 2022 in one example receives a portion of the lever component 2012. The one or more attachment components 2024 in one example extends through the one ore more of an attachment passage 2026 and is received by the one or more attachment recesses 2017. In one example, the attachment components 2024 serve to connect the interface component 2010 to the lever component 2012. In another example, the interface component 2010 serves to improve an ability of the user to relocate the lever component 2012 in the unit component 1910, as described herein.

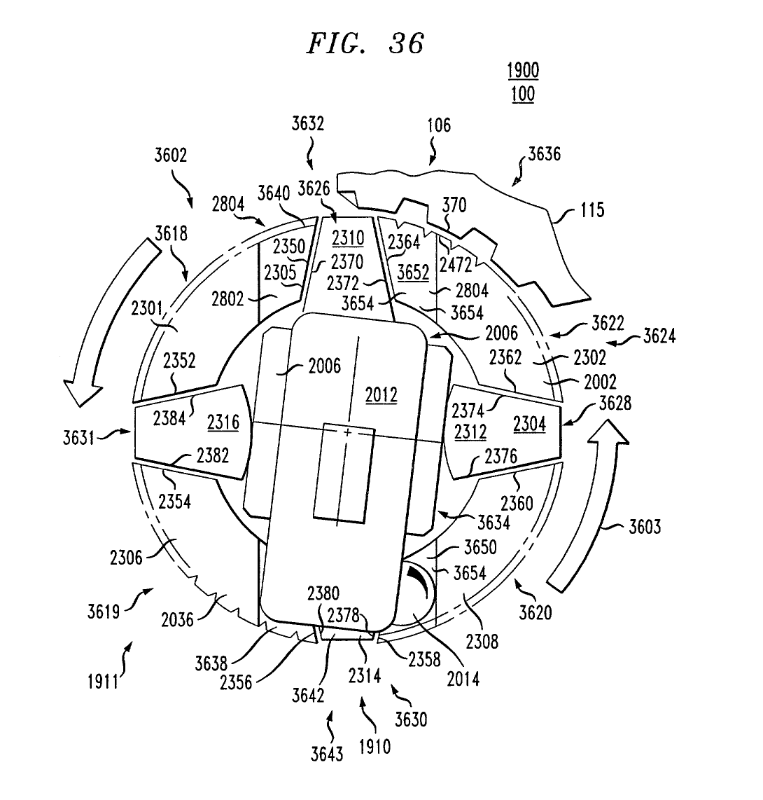

Referring to FIGS. 28 and 36, the one of the four force distribution components 2002 in one example comprises a first recess 2802. In one example, the first two of the four force distribution components 2002 comprise a dimension 2808 and the second two of the four force distribution components comprise a dimension 2806. For example, the dimension 2808 and the dimension 2806 are not substantially the same length. In another example, the dimensions 2808 and 2806 comprise different lengths. The four force distribution components serve to form a passage 2804. In one example, the passage 2804 is a channel formed in the four force distribution components 2002. In another example, the passage 2804 is offset from the center of the four force distribution components 2002. For example, the center of the passage 2804 does not coincide with the center of the arrangement of the four force distribution components 2002. In a further example, the offset of the passage 2804 and the lever component 2012 serve to assist in the control of force transmission of device 1900, as described herein. In still a further example, the passage 2804 allows the lever component 2012 to be moved in the unit component 1910 as described herein.

Referring to FIGS. 26, 28, and 36, the second force coupler component 2006 comprises a passage 2602. In one example, the passage 2602 receives a portion of the lever component 2012. Passages 2804 and 2602 in one example form a passage 3638. In one example, the passage 3638 comprises a track. In another example, the passage 3638 serves to receive the lever component 2012 and allows the lever component 2012 to be located at one or more positions within the passage 3638, as described herein. In a further example, the passage 3638 serves to allow the lever component 2012 to be relocated in the unit component 1910. The passage 3638 in one example comprises a subportion 3640 and a subportion 3642. In one example, a subportion 3643 comprises the subportions 3640 and 3642. In another example, the subportions 3640 and 3642 receive a portion of the lever component 2012 as described herein.

Referring again to FIG. 36, in one example, positioning a portion of the lever component in the subportion 3642 causes one of the one or more spring components 2014 to extend a portion of one of the one or more detent components 2014 into a first pocket portion 3650. In one example, positioning the portion of the lever component in the subportion 3640 causes one of the one or more spring components 2014 to extend one of the one or more detent components 2014 into a second pocket portion 3652. For example, the first pocket portion 3650 and the second pocket portion 3652 comprise an area between the lever component 2012 and one of the four force distribution components 2002. In one example, a pocket portion 3654 comprises the first pocket portion 3650 and the second pocket portion 3652.

Referring still to FIG. 36, in one example where the portion of the lever component 2012 is located in the subportion 3643, extending the spring component 2013 in the pocket portion 3654 serves to abut the spring component 2013 and one of the four distribution components 2002. In one example, the spring components 2013 being abut the one of the four force distribution components 2002 serves to promote maintenance of the portion of the lever component 2012 in the subportion 3643. In one example, abutment of the one of the one or more detent components 2014 maintain the location of the portion of the lever component 2012 in the subportion 3643. For example, the one of the one or more detent component 2014, the one of the one or more spring component 2016, and the one of the four force distribution components 2002 serve to present a defined threshold of force for removable engagement of the portion of the lever component 2012 from location in the subportion 3643, as described herein.

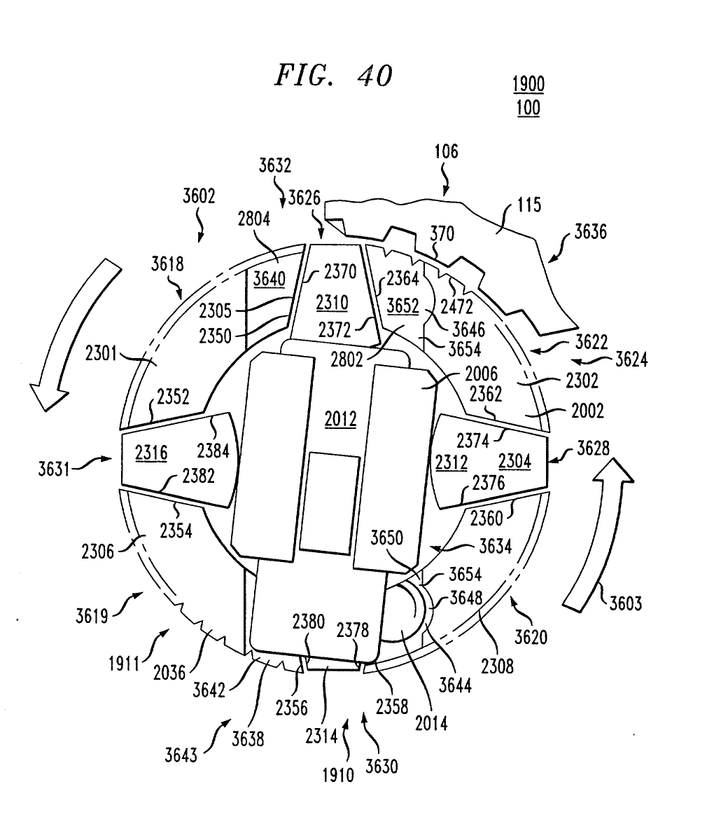

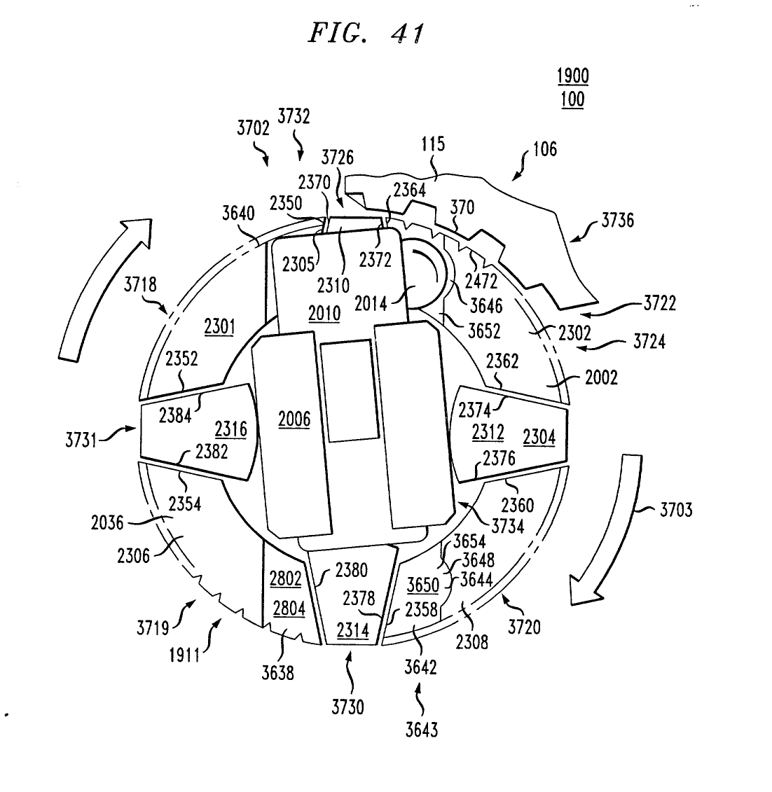

Referring to FIG. 40, in one example the first pocket portion 3650 comprises a recess 3648 and the second pocket portion 3652 comprises a recess 3646. In one example, a second recess 3644 comprises the recesses 3646 and 3648. For example, the second recess 3644 serves to receive one of the one or more detent components 2014 when the portion of the lever component is located in the subportion 3643. In another example, the second recess 3644 serves to improve the ability to maintain the location of the portion of the lever component 2012 in the subportion 3643.

An illustrative description of exemplary operation of the four force distribution components 2002 and the four spreader component 2304 is presented herein, for explanatory purposes.

Referring to FIGS. 23 and 38, force coupler component 306 comprises force coupler component 2006. Second force coupler component 2006 in one example comprises four face portions 2360. The face portion 2360 in one example comprises substantially flat face portion 2362. Exemplary instances of face portion 2360 comprise substantially flat face portions 2353, 2355, 2357, and 2359. In a further example, second force coupler component 2006 comprises central pivot component 3826 and drive component 328. Central pivot component 3826 in one example comprises center body component 3830. In another example, central pivot component 3826 is a wrench central pivot component. Drive component 328 in one example comprises drive tang component 332. In one example, drive component 328 serves to removably engage socket 1402 (FIG. 14). For example, drive component 328 telescopes in the socket 1402 (FIG. 14). In a further example, drive component 328 transmits force to the socket. For example, drive component 328 serves to transmit rotational force to the socket 1402 (FIG. 14), for example, for subsequent force transmission to head 1404 (FIG. 14) of bolt 1406 (FIG. 14), as will be appreciated by those skilled in the art.

Referring to FIGS. 19 and 25, unit component 1910 in one example serves to allow one or more advantageously small instances of finite angular movement 1911 between the first force coupler components 115 and four force distribution components 2002. For example, the four force distribution components 2002, the four spreader components 2304, and the second force coupler component 2006 in one example serve to allow the one or more instances of finite angular movement 1911. In one example, one or more of the one or more instances of finite angular movement 1911 is less than or equal to five degrees. In another example, one or more of the one or more instances of finite angular movement 1911 is less than or equal to four degrees. In a further example, one or more of the one or more instances of finite angular movement 1911 is less than or equal to three degrees. In a still further example, unit component 1910 serves to allow a plurality of instances of finite angular movement 1911 to be substantially uniform in size, for example, varying by less than one half of a degree.

Referring to FIG. 36, the location of the passage 2804 offset from the center of the unit component 1910 in one example serves to assist the lever component 2012 to control force transmission. In one example, the portion of the lever component 2012, upon being located in the subportion 3643, is positioned in the passage 2804 nearer to a second of the four force distribution components 2002 than a first of the four force distribution components 2002. For example, during a first angular rotation of the device 1900 with the portion of the lever component in the subportion 3643, lever component 2012 will contact the second of the four force distribution components 2002 and prevent the second force coupler component 2006 from contacting the four force distribution components 2002 as described herein.

Still referring to FIG. 36, in another example, during a second angular rotation of the device 1900 with the portion of the lever component 2012 in the subportion 3643, the lever component 2012 will not contact the first of the four force distribution components 2002 and allows the second force coupler component 2301 to contact the four force distribution components 2006, as described herein. In another example, the passage 2804 and the portion of the lever component 2012 being located in the subportion 3643 allows the second force coupler component 2006 to move relative to the spreader components 2304 more in a first angular direction than the second angular direction.

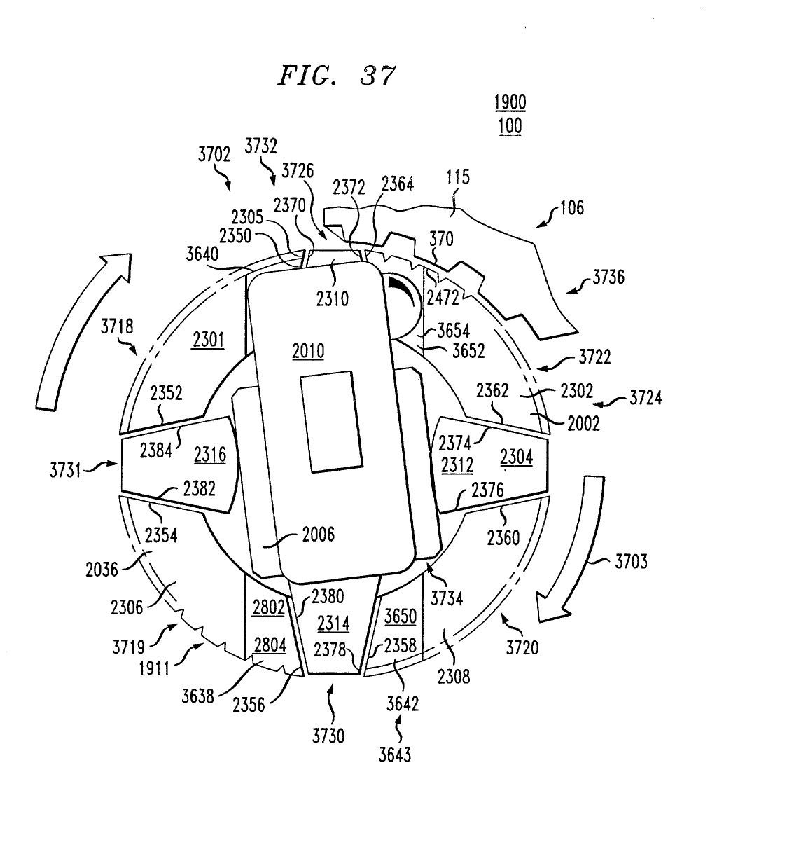

Referring to FIG. 37, in one example the lever component 2012, the one or more spring components 2016, and the one or more detent components 2014 serve to control force transmission between the unit component 1910 and the first force coupler component 115. In one example, force transmission is dependent on the location of the lever component in the unit component 1910 as described herein. In another example, a portion of the lever component 2012 is located in the subportion 3640 and serves to allow force transmission between the first force coupler component 115 and the unit component 1910 in a first of two angular directions. In yet another example, the lever component 2012, in the first angular direction, allows the second force coupler component 2006 to contact the four spreader components 2304 that serve to create force transmission between the unit component 1910 and the first coupler component 115 as described herein. In a second angular direction, the lever component 2012 contacts one of the four force distribution components that serves to prevent the second force coupler component 2006 from contacting the four force spreader components 2304 and serves to create substantially no force transmission between the unit component 1910 and the first force coupler component 115. In still another example, force transmission occurs in the first angular direction and substantially no force transmission occurs in the second angular direction.

Referring to FIG. 36, in one example, a portion of the lever component 2012 is located in a subportion 3642 and serves to allow force transmission between the first force coupler component 115 and the unit component 1910 in a second of two angular directions. In another example, the lever component 2012, in the second angular direction, allows the second force coupler component 2006 to contact the four spreader components 2304 that serve to create force transmission between the unit component 1910 and the first coupler component 115 as described herein. In a first angular direction, the lever component 2012 contacts one of the four force distribution components 2002 that serves to prevent the second force coupler component 2006 from contacting the four force spreader components 2304 and serves to create substantially no force transmission between the unit component 1910 and the first force coupler component 115. In another example, force transmission occurs in the second angular direction and substantially no force transmission occurs in the first angular direction.

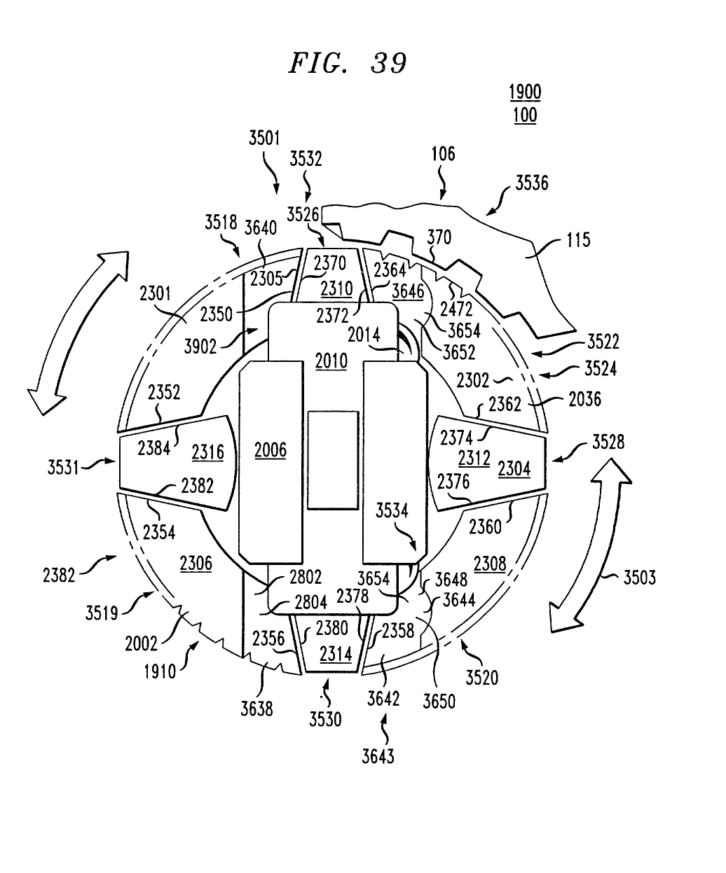

Referring to FIG. 39, in one example, the lever component 2012 is located in a third position 3902 that serves to create substantially no force transmission in the two angular directions. In one example, the lever component is located in between the subportions 3640 and 3642. In another example, the unit 1910 allows operation of the device 1900 in the first and second angular directions without force transmission between the unit component 1910 and the first force coupler component 115. In another example, the lever component 106 moves in the two angular directions without moving the unit component 1910. In a further example, the lever component 106 is movable in each of the two angular directions when the unit component 1910 is attached to a socket 1402 (FIG. 14).

Now is presented an illustrative description of exemplary operation of four force distribution components 2002, four spreader components 2304, the second force coupler component 2006, the first force coupler component 115, the lever component 2012, the interface component 2010, the cap component 2008, the one or more spring components 2016, and the one or more detent components 2014.

Referring to FIGS. 23 and 35, the unit component 1910 of device 1900 in one example is located at position 3501. Position 3501 in one example serves as a transitional position between positions 3601 (FIG. 36) and 3701 (FIG. 37), as described herein. In one example, position 3501 comprises a position of neutral (e.g., angular) movement of unit component 1910 of device 1900. For example, directions 3503 are available to unit component 1910 at position 3501 for angular movement with substantially no force transmission to one or more instances of the first force coupler component 115, as will be appreciated by those skilled in the art.

Referring to FIGS. 23 and 39, in one example the user locates unit component 1910 at position 3501 by sliding interface component 2010 in a direction radially inward to the cap component 2008 that slides the lever component 2012 in the direction and disengages one of the one or more detent components 2014 from the pocket portion 3654, as will be appreciated by those skilled in the art. In another example, a portion of the detent components 2014 are received into a portion of the second force coupler component 2006. In a further example, the portion of the lever component 2012 is moved out of the subportion 3643 and is located at the position 3902.

Referring to FIG. 35, at position 3501 of the unit component 1910 in one example, force distribution components 2301, 2302, 2306, and 2308 are located at positions 3518, 3519, 3520, and 3522, respectively. Positions 3518,3519, 3520, and 3522 in one example comprise set 3524 of positions for four force distribution components 2002. Spreader components 2310, 2312, 2314, and 2316 in one example are located at positions 3526, 3528, 3530 and 3531. Positions 3526, 3528, 3530, and 3531 in one example comprise set 3532 of positions for four spreader component 2304. Sets 3524 and 3532 of positions in one example comprises positions of relatively unforced fit and/or contact between substantially flat face portions 2350, 2352, 2354, 2356,2358, 2360, 2362, and 2364 and substantially flat face portions 2370, 2372, 2374, 2376, 2378, 2380,2382, and 2384 respectively. For example, sets 3524 and 3532 of positions comprise neutral positions of force distribution component 2002 and spreader component 2304.

Again referring to FIG. 35, at position 3501 of unit component 1910, force coupler components 2006 and 115 in one example are located at positions 3534 and 3536, respectively. In one example, position 3534 of second force coupler component 2006 comprises a position of forced contact and/or engagement between second force coupler component 2006 and socket 1402 (FIG. 14) and/or between second force coupler component 2006 and spreader components 2310, 2312, 2314, and 2316. In another example, position 534 of second force coupler component 2006 comprises a position of relatively unforced contact and/or engagement between second force coupler component 2006 and socket 1402 (FIG. 14) and/or between second force coupler component 2006 and spreader components 2310, 2312, 2314, and 2316, and 2316. Position 3536 of the first force coupler component 115 in one example comprises a position of relative, rotational, substantially non-force transmission between first force coupler component 115 and force distribution components 2301, 2302, 2306, and 2308. For example, position 3536 comprises a neutral position of the first force coupler component 115.

Referring to FIGS. 20 and 39, at position 3501 of unit component 1910 in one example relocation of interface component 2010 serves to relocate the lever component 2012 in the passage 3638. For example, a user moves or pivots interface component 2010 to obtain relocation of the lever component 2012, as will be appreciated by those skilled in the art. In another example, the user relocates the portion of the lever component 2012 from the subportion 3640 to the subportion 3642 or from the subportion 3642 to the subportion 3640, as will be appreciated by those skilled in the art. In a further example, relocating the lever component 2012 serves to cause the spring components 2016 to extend the detent components 2014 into the pocket portion 3654. In yet a further example, relocating the lever component 2012 serves to cause the spring components 2016 to retract the detent components 2014 from the pocket portion 3654.

Referring to FIG. 36, unit component 1910 of device 1900 in one example is located at position 3602. In one example, position 3602 comprises a position of forward and/or counterclockwise angular movement of unit component 1910 of device 1900. For example, direction 3603 is available to unit component 1910 at position 3602 for angular movement that causes force transmission with one or more instances of the first force coupler component 115. At position 3602 in one example, an angular direction opposite to direction 3603 is available to lever component 106 for angular rotation of lever component 106 that causes substantially no force transmission with one or more instances of the first force coupler component 115. Device 1900 in one example serves to allow one or more instances of finite angular movement 1911 of lever component 106 with unit component 1910 in direction 3603, and/or one or more instances of finite angular movement 1911 of lever component 106 without unit component 1910 in an angular direction opposite to direction 3603, as will be appreciated by those skilled in the art.

Still referring to FIG. 36, at position 3602 in one example one or more instances of finite angular movement 1911 of lever component 106 with unit component in direction 3603 serves to abut and/or engage a portion of one or more instances of protuberance 2472 with a portion of one or more instances of protuberance 370, for example, to promote force transmission between four force distribution component 2002 and one or more instances of the first force coupler component 115. In a further example, at position 3602 one or more instances of finite angular movement 1911 of lever component 106 without unit component 1910 in an angular direction opposite to direction 3603 serves to contact a portion of one or more instances of protuberance 2472 with a portion of one or more instances of protuberance 370, for example, to produce one or more audible sounds, for instance, one or more clicks. One or more of abutment, engagement, and contact of a portion of one or more instances of protuberance 2472 with a portion of one or more instances of protuberance 370 at position 3602 in one example serves to present to the user of device 1900 a sound and/or feel of a ratchet wrench that comprises a lever component and a pawl mechanism drive element (not shown).

Again referring to FIG. 36, at position 3602 of unit component 1910 in one example, force distribution components 2301, 2302, 2306, and 2308 are located at positions 3618, 3619, 3620, and 3622, respectively. Positions 3618, 3619, 3620, and 3622 in one example comprise set 3624 of positions for four force distribution components 2002. Spreader components 2310, 2312, 2314, and 2316 in one example are located at positions 3626, 3228, 3630, and 3631. Positions 3626, 3228, 3630, and 3631 in one example comprise set 3632 of positions for four spreader components 2304. Sets 3624 and 3632 of positions in one example comprises positions of relatively forced fit and/or contact between substantially flat face portions 2350, 2352, 2354, 2356, 2358, 2360, 2362, 2364 and substantially flat face portions 2370, 2372, 2374, 2376, 2378, 2380, 2382, 2384, respectively. For example, sets 3624 and 3632 of positions comprise forward and/or counterclockwise torque positions of force distribution component 2002 and spreader component 2304.

Still referring to FIG. 36, at position 3602 of unit component 1910, force coupler components 2006 and 115 in one example are located at positions 3634 and 3636, respectively. Position 3634 of second force coupler component 2006 in one example comprises a position of forced contact and/or engagement between second force coupler component 2006 and socket 1402 (FIG. 14) as well as between second force coupler component 2006 and spreader components 2310, 2312, 2314, and 2316. Position 3636 of the first force coupler component 115 in one example comprises a position of forced contact and/or engagement between the first force coupler component 115 and force distribution components 2301, 2302, 2306, and 2308.

Referring to FIGS. 20 and 36 at the position 3602 of the unit component 1910 in one example the interface component 2010, upon a relocation of the portion of the lever component 2012 into the subportion 3642, serves to allow force transmission between one or more instances of the first force coupler component 115 and unit component 1910 based on direction 3603 of angular rotation of the unit component 1910. In one example, the relocation of the interface component 2010 causes one of the one or more spring components 2016 to extend the detent components 2014 into the first pocket portion 3650. In another example, the detent components 2014 maintain the portion of the lever component 2012 in the subportion 3642. In yet another example, the relocation of the lever component 2012 causes the lever component 2012 to be nearer to the force coupler component 2306 than 2308. For example, the second force coupler component 2006 can contact the four spreader components 2304 in the angular direction 3603. In another example, the second force coupler component 2006 can not contact the four force spreader components 2304 in a angular direction opposite to the angular direction 3603.

Referring to FIG. 36, at position 3602 in one example angular rotation of second force coupler component 2006 in direction 3603 serves to contact second force coupler component 2006 with spreader components 2310, 2312, 2314, and 2316 and press spreader components 2310, 2312, 2314, and 2316 into force distribution components 2301, 2302, 2306, and 2308 to press force distribution components 2301, 2302, 2306, and 2308 against the first force coupler component 115 for force transmission to the first force coupler component 115 in direction 3603. Pressing of spreader components 2310, 2312, 2314, and 2316 into force distribution components 2301, 2302, 2306, and 2308 in one example comprises sliding contact of substantially flat face portions 2350, 2352, 2354, 2356, 2358, 2360, 2362, 2364 with substantially flat face portions 2370, 2372, 2374, 2376, 2378, 2380, 2382, 2384, respectively, that in one example results in radially outward movement and compressive contact among spreader components 2310, 2312, 2314, and 2316 and force distribution components 2301, 2302, 2306, and 2308.

Further referring to FIG. 36, at position 3602 in another example angular rotation of the first force coupler component 115 in direction 3603 presses the first force coupler component 115 against force distribution components 2301, 2302, 2306, and 2308 to press together force distribution components 2301, 2302, 2306, and 2308 and spreader components 2310, 2312, 2314, and 2316 while pressing spreader components 2310, 2312, 2314, and 2316 against second force coupler component 2006 for force transmission to second force coupler component 2006 in direction 3603. Pressing together of spreader components 2310, 2312, 2314, and 2316 and force distribution components 2301, 2302, 2306, and 2308 in one example comprises sliding contact of substantially flat face portions 2350, 2352, 2354, 2356, 2358, 2360, 2362, 2364 with substantially flat face portions 2370, 2372, 2374, 2376, 2378, 2380, 2382, 2384, respectively, that in one example results in radially outward movement and compressive contact among spreader components 2310, 2312, 2314, and 2316 and force distribution components 2301, 2302, 2306, and 2308.

Referring to FIGS. 25 and 36, sliding contact of substantially flat face portions 2350, 2352, 2354, 2356, 2358, 2360, 2362, 2364 in one example comprises employment of respective instances of rake 2578. In a further example, sliding contact of substantially flat face portions 2370, 2372, 2374, 2376, 2378, 2380, 2382, 2384 comprises employment of respective instances of rake 2580. In one example, a plurality of instances of rake 2578 and/or 2580 serve to advantageously one or more or distribute, enhance, and increase security of force transmitted from second force coupler component 2006, through spreader components 2310, 2312, 2314, and 2316, through force distribution components 2301, 2302, 2306, and 2308, to the first force coupler component 115. In a further example, a plurality of instances of rake 2578 and/or 2580 serve to advantageously one or more or distribute, enhance, and increase security of force transmitted from the first force coupler component 115, through force distribution components 2301, 2302,2306, and 2308, through spreader components 2310, 2312, 2314, and 2316, to second force coupler component 2006.

Referring to FIG. 23, contact of second force coupler component 2006 with spreader components 2310, 2312, 2314, and 2316 in one example comprises camming contact of substantially flat face portions 2353, 2355, 2357, and 2359 with substantially curved face portions 2390,2392, 2394, and 2396, respectively. Camming contact in one example comprises contact among a substantially curved face portion with one or more other face portions, one or more of which in one example are substantially curved, in another example are substantially flat, and in yet another example comprise one or more other shapes, as will be appreciated by those skilled in the art.

Turning to FIG. 37, unit component 1910 of device 1900 in one example is located at position 3702. In one example, position 3702 comprises a position of reverse and/or clockwise angular movement of unit component 1910 of device 1900. For example, direction 3703 is available to unit component 1910 at position 3702 for angular movement that causes force transmission with one or more instances of the first force coupler component 115. At position 3702 in one example, an angular direction opposite to direction 3703 is available to lever component 106 for angular rotation of lever component 106 that causes no force transmission between one or more instances of the first force coupler component 115 and the unit component 1910. Device 1900 in one example serves to allow one or more instances of finite angular movement 1911 of lever component 106 with unit component 1910 in direction 3703, and/or one or more instances of finite angular movement 1911 of lever component 106 without unit component 1910 in an angular direction opposite to direction 3703, as will be appreciated by those skilled in the art.

Still referring to FIG. 37, at position 3702 in one example one or more instances of finite angular movement 1911 of lever component 106 with unit component in direction 3703 serves to abut and/or engage a portion of one or more instances of protuberance 2472 with a portion of one or more instances of protuberance 370, for example, to promote force transmission between a plurality of instances of force distribution component 2002 and one or more instances of the first force coupler component 115. In a further example, at position 3702 one or more instances of finite angular movement 1911 of lever component 106 without unit component 1900 in an angular direction opposite to direction 3703 serves to contact a portion of one or more instances of protuberance 2472 with a portion of one or more instances of protuberance 370, for example, to produce one or more audible sounds, for instance, one or more clicks. One or more of abutment, engagement, and contact of a portion of one or more instances of protuberance 2472 with a portion of one or more instances of protuberance 370 at position 3702 in one example serves to present to the user of device 1900 a sound and/or feel of a ratchet wrench that comprises a lever component and a pawl mechanism drive element (not shown).

Again referring to FIG. 37, at position 3702 of unit component 1910, force distribution components 2301, 2302, 2306, and 2308 in one example are located at positions 3718,3719, 3720, and 3722, respectively. Positions 3718, 3719, 3720, and 3722 in one example comprise set 3724 of positions for four force distribution components 2002. Spreader components 2310, 2312, 2314, and 2316 in one example are located at positions 3726, 3728, 3730 and 3731. Positions 3726, 3728, 3730 and 3731 in one example comprise set 3732 of positions for a plurality of instances of spreader component 2304. Sets 3724 and 3732 of positions in one example comprises positions of relatively forced fit and/or contact between substantially flat face portions 2350, 2352, 2354, 2356, 2358, 2360, 2362, 2364 and substantially flat face portions 2370, 2372, 2374, 2376, 2378, 2380, 2382, 2384, respectively. For example, sets 3724 and 3732 of positions comprise reverse and/or clockwise torque positions of force distribution component 2002 and spreader component 2304.

Still referring to FIG. 37, at position 3702 of unit component 1910, force coupler components 2006 and 115 in one example are located at positions 3734 and 3736, respectively. Position 3734 of second force coupler component 2006 in one example comprises a position of forced contact and/or engagement between second force coupler component 2006 and socket 1402 (FIG. 14) as well as between second force coupler component 2006 and spreader components 2310, 2312, 2314, and 2316. Position 3736 of the first force coupler component 115 in one example comprises a position of forced contact and/or engagement between the first force coupler component 115 and force distribution components 2301, 2302, 2306, and 2308.

Referring to FIGS. 20 and 37 at the position 3702 of the unit component 1910 in one example the interface component 2010, upon a relocation of the portion of the lever component 2012 into the subportion 3640, serves to allow force transmission between one or more instances of the first force coupler component 115 and the unit component 1910 based on the direction 3703 of angular rotation of the unit component 1910. In one example, the relocation of the interface component 2010 causes one of the one or more spring components 2016 to extend the detent components 2014 into the second pocket portion 3652. In another example, the detent components 2014 maintain the portion of the lever component 2012 in the subportion 3642. In yet another example, the relocation of the lever component 2012 causes the lever component 2012 to be nearer to the force coupler component 2301 than 2302. For example, the second force coupler component 2006 can contact the four spreader components 2304 in the angular direction 3703. In another example, the second force coupler component 2006 can not contact the four force spreader components 2304 in a angular direction opposite to the angular direction 3603.

Referring again to FIG. 37 at position 3702 in one example angular rotation of second force coupler component 2006 in direction 3703 presses spreader components 2310, 2312, 2314, and 2316 into force distribution components 2301, 2302, 2306, and 2308 to press force distribution components 2301, 2302, 2306, and 2308 against the first force coupler component 115 for force transmission to the first force coupler component 115 in direction 3703. Pressing of spreader components 2310, 2312, 2314, and 2316 into force distribution components 2301, 2302, 2306, and 2308 in one example comprises sliding contact of substantially flat face portions 2350, 2352, 2354, 2356, 2358, 2360, 2362, 2364 with substantially flat face portions 2370, 2372, 2374, 2376, 2378, 2380, 2382, 2384, respectively, that in one example results in radially outward movement and compressive contact among spreader components 2310, 2312, 2314, and 2316 and force distribution components 2301, 2302, 2306, and 2308, as will be appreciated by those skilled in the art.

Further referring to FIG. 37, at position 3702 in another example angular rotation of the first force coupler component 115 in direction 3703 presses the first force coupler component 115 against force distribution components 2301, 2302, 2306, and 2308 to press together force distribution components 2301, 2302, 2306, and 2308 and spreader components 2310, 2312, 2314, and 2316 while pressing spreader components 2310, 2312, 2314, and 2316 against second force coupler component 2006 for force transmission to second force coupler component 2006 in direction 3703. Pressing together of spreader components 2310, 2312, 2314, and 2316 and force distribution components 2301, 2302, 2306, and 2308 in one example comprises sliding contact of substantially flat face portions 2350, 2352, 2354, 2356, 2358, 2360, 2362, 2364 with substantially flat face portions 2370, 2372, 2374, 2376, 2378, 2380, 2382, 2384, respectively, that in one example results in radially outward movement and compressive contact among spreader components 2310, 2312, 2314, and 2316 and force distribution components 2301, 2302, 2306, and 2308, as will be appreciated by those skilled in the art.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A device, comprising:
four force distribution components that, upon operative location of the four force distribution components relative to one or more force coupler components, are movable among a plurality of first positions relative to the one or more force coupler components, wherein the four force distribution components comprise a force distribution component that comprises one or more substantially flat first face portions; and
four spreader components that are movable among a plurality of second positions relative to the four force distribution components, wherein the four spreader components comprise a spreader component that comprises one or more substantially flat second face portions;
wherein location of the four spreader components at one or more force transmission position sets of the plurality of second positions causes, through employment of contact of one or more of the one or more substantially flat first face portions with one or more of the one or more substantially flat second face portions, location of the four force distribution components at one or more force transmission position sets of the plurality of first positions.

2. The device of claim 1, wherein the one or more force transmission position sets of the plurality of second positions comprise one or more first force transmission position sets of the plurality of second positions, wherein the one or more force transmission position sets of the plurality of first positions comprise one or more first force transmission position sets of the plurality of first positions, wherein the force distribution component comprises a first force distribution component, wherein the four force distribution components comprise a second force distribution component that comprises one or more substantially flat third face portions;
wherein the spreader component comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the four spreader components at one or more second force transmission position sets of the plurality of second positions causes, through employment of contact of one or more of the one or more substantially flat third face portions with one or more of the one or more substantially flat fourth face portions, location of the four force distribution components at one or more second force transmission position sets of the plurality of first positions.

3. The device of claim 2, wherein the first force distribution component comprises one or more substantially flat fifth face portions, wherein the four force distribution components comprise a third force distribution component, wherein the spreader component comprises a first spreader component, wherein the four spreader components comprise a second spreader component, wherein the second spreader component comprises one or more substantially flat sixth face portions;
wherein location of the four spreader components at the one or more second force transmission position sets of the plurality of second positions causes, through employment of contact of the one or more of the one or more substantially flat third face portions with the one or more of the one or more substantially flat fourth face portions and contact of the one or more of the one or more substantially flat fifth face portions with the one or more of the one or more substantially flat sixth face portions, location of the four force distribution components at the one or more second force transmission position sets of the plurality of first positions.

4. The device of claim 3, wherein the four force distribution components comprise a third force distribution component, wherein the third force distribution component comprises one or more substantially flat seventh face portions, wherein the second spreader component comprises one or more substantially flat eighth face portions;
wherein location of the four spreader components at the one or more first force transmission position sets of the plurality of second positions causes, through employment of contact of the one or more of the one or more substantially flat first face portions with the one or more of the one or more substantially flat second face portions and contact of one or more of the one or more substantially flat seventh face portions with one or more of the one or more substantially flat eighth face portions, location of the four force distribution components at the one or more first force transmission position sets of the plurality of first positions.

5. The device of claim 1, wherein the force distribution component comprises a first force distribution component, wherein the four force distribution components comprise a second force distribution component, wherein the spreader component comprises a first spreader component, wherein the four spreader components comprise a second spreader component;
wherein the second force distribution component comprises one or more substantially flat third face portions, wherein the spreader component comprises one or more substantially flat fourth face portions;
wherein location of the four spreader components at the one or more force transmission position sets of the plurality of second positions causes, through employment of contact of the one or more of the one or more substantially flat first face portions with the one or more of the one or more substantially flat second face portions and contact of one or more of the one or more substantially flat third face portions with one or more of the one or more substantially flat fourth face portions, location of the four force distribution components at the one or more force transmission position sets of the plurality of first positions.

6. The device of claim 1, wherein the one or more force coupler components comprise one or more first force coupler components, wherein the spreader component comprises a first spreader component, wherein the four spreader components comprise a second spreader component, and further comprising:
one or more second force coupler components that are movable among a plurality of third positions relative to the four spreader components;
wherein location of the one or more second force coupler components at one or more force transmission position sets of the plurality of third positions causes, through employment of contact among one or more portions of the first spreader component and one or more first portions of the one or more second force coupler components and contact among one or more portions of the second spreader component and one or more second portions of the one or more second force coupler components, location of the four spreader components at the one or more force transmission position sets of the plurality of second positions.

7. The device of claim 6, wherein one or more of the one or more portions of the first spreader component comprise one or more substantially curved face portions of the first spreader component, wherein one or more of the one or more portions of the second spreader component comprise one or more substantially curved face portions of the second spreader component;
wherein location of the one or more second force coupler components at one or more force transmission position sets of the plurality of third positions causes, through employment of camming contact among one or more of the one or more substantially curved face portions of the first spreader component and the one or more first portions of the one or more second force coupler components and camming contact among one or more of the one or more substantially curved face portions of the second spreader component and the one or more second portions of the one or more second force coupler components, location of the four spreader components at the one or more force transmission position sets of the plurality of second positions.

8. The device of claim 7, wherein the four spreader components comprise four wedge components, wherein the first spreader component comprises a first wedge component of the four wedge components, wherein the second spreader component comprises a second wedge component of the four wedge components;
wherein the one or more second force coupler components comprise a wrench central pivot component that is operatively movable among the plurality of third positions relative to the four wedge components.

9. The device of claim 6, wherein a pivot of one or more of the one or more second force coupler components from a first instance of the plurality of third positions to a second instance of the plurality of third positions, upon operative location of the four force distribution components relative to the one or more first force coupler components, serves to press the four spreader components against the four force distribution components and cause four force distribution components to press against the one or more first force coupler components.

10. The device of claim 6, wherein the four force distribution components, the four spreader components, and the one or more second force coupler components serve to allow one or more finite angular movements between the one or more first force coupler components and the four force distribution components;
wherein one or more of the one or more finite angular movements is less than or equal to five degrees.

11. The device of claim 6, wherein the four force distribution components, the four spreader components, and the one or more second force coupler components serve to allow one or more finite angular movements between the one or more first force coupler components and the four force distribution components;
wherein one or more of the one or more finite angular movements is less than or equal to four degrees.

12. The device of claim 6, wherein the four force distribution components, the four spreader components, and the one or more second force coupler components serve to allow one or more finite angular movements between the one or more first force coupler components and the four force distribution components;
wherein one or more of the one or more finite angular movements is less than or equal to three degrees.

13. The device of claim 1, wherein the one or more force coupler components comprise one or more first force coupler components, and further comprising:
one or more second force coupler components that are movable among a plurality of third positions relative to the four spreader components;
wherein location of the one or more second force coupler components at one or more force transmission position sets of the plurality of third positions causes, through employment of contact among one or more portions of the spreader component and one or more portions of a force coupler component of the one or more second force coupler components, location of the four spreader components at one or more force transmission position sets of the plurality of second positions.

14. The device of claim 13, wherein one or more of the one or more portions of the spreader component comprise one or more substantially curved face portions of the spreader component;
wherein location of the one or more second force coupler components at one or more force transmission position sets of the plurality of third positions causes, through employment of camming contact among one or more of the one or more substantially curved face portions and one or more portions of a force coupler component of the one or more second force coupler components, location of the four spreader components at one or more force transmission position sets of the plurality of second positions.

15. The device of claim 14, wherein the four spreader components comprise four wedge components, wherein the spreader component comprises a wedge component of the four wedge components;
wherein the one or more second force coupler components comprise a wrench central pivot component that is operatively movable among the plurality of third positions relative to the four wedge components.

16. The device of claim 13, wherein a pivot of one or more of the one or more second force coupler components from a first instance of the plurality of third positions to a second instance of the plurality of third positions, upon operative location of the four force distribution components relative to the one or more first force coupler components, serves to press the four spreader components against the four force distribution components and cause the four force distribution components to press against the one or more first force coupler components.

17. The device of claim 13, wherein the four force distribution components, the four spreader components, and the one or more second force coupler components are one or more of operatively connectable with and disconnectable from the one or more first force coupler components as a unit.

18. The device of claim 17, further comprising a lever component;
wherein location of the lever component at an instance of a plurality of fourth positions relative to a portion of the one or more first force coupler components, upon operative location of the lever component relative to the one or more first force coupler components, serves to allow force transmission between the one or more first force coupler components and the unit based on a direction of angular rotation of the unit.

19. The device of claim 18, further comprising:
one or more detent components; and
one or more spring components, wherein a spring component of the one or more spring components is engaged with a detent component of the one or more detent components;
wherein location of the lever component at the instance of the plurality of fourth positions serves to allow the spring component to cooperate with the detent component and promote maintenance of the lever component at the instance of the plurality of fourth positions.

20. The device of claim 19, wherein the direction of angular rotation of the unit comprises a first direction of angular rotation of the unit;
wherein location of the lever component at the instance of the plurality of fourth positions causes the spring component to move a portion of the detent component into a pocket portion and allow relocation of the one or more first force coupler components based on a second direction of angular rotation of the unit substantially without force transmission between the one or more second force coupler components and the four spreader components.

21. The device of claim 20, wherein a portion of the four force distribution components comprises a recess that comprises a portion of the pocket portion;
wherein location of the lever component at the instance of the plurality of fourth positions serves to move a portion of the detent component into a portion of the recess and promote maintenance of the lever component at the instance of the plurality of fourth positions.

22. The device of claim 20, wherein the instance of the plurality of fourth positions comprises a first instance of the plurality of fourth positions, wherein the direction of angular rotation of the unit comprises a first direction of angular rotation of the unit, wherein the detent component comprises a first detent component, wherein the spring component comprises a first spring component, wherein the pocket portion comprises a first pocket portion;
wherein location of the lever component at a second instance of the plurality of fourth positions causes a second spring component of the one or more spring components to move a portion of a second detent component of the one or more detent components into a second pocket portion and allow relocation of the one or more first force coupler components based on the first direction of angular rotation of the unit substantially without force transmission between the one or more second force coupler components and the four spreader components.

23. The device of claim 19, wherein the instance of the plurality of fourth positions comprises a first instance of the plurality of fourth positions, wherein the detent component comprises a first detent component, wherein the spring component comprises a first spring component;
wherein location of the lever component at a second instance of the plurality of fourth positions serves to allow a second spring component of the one or more spring components to cooperate with a second detent component of the one or more detent components and promote maintenance of the lever component at the second instance of the plurality of fourth positions.

24. The device of claim 13, wherein the one or more first force coupler components comprise a first force coupler component, wherein the first force coupler component comprises an opening;
wherein the four force distribution components, the four spreader components, and the one or more second force coupler components are one or more of operatively locatable at least partially within and operatively disconnectable from the opening of the first force coupler component as a unit.

25. The device of claim 24, wherein the unit comprises a major dimension that is less than or equal to 0.03175 meters and greater than or equal to 0.01905 meters.

26. The device of claim 25 in combination with the first force coupler component, wherein the opening comprises a substantially circular opening;
wherein the substantially circular opening comprises a diameter that is less than or equal to 0.03175 meters and greater than or equal to 0.01905 meters, wherein the substantially circular opening comprises a depth that is less than or equal to 0.01905 meters and greater than or equal to 0.0127 meters.

27. The device of claim 24, wherein the unit comprises a major dimension that is less than or equal to 0.01905 meters and greater than or equal to 0.0127 meters.

28. The device of claim 27 in combination with the first force coupler component, wherein the opening comprises a substantially circular opening;
wherein the substantially circular opening comprises a diameter that is less than or equal to 0.01905 meters and greater than or equal to 0.0127 meters, wherein the substantially circular opening comprises a depth that is less than or equal to 0.009525 meters and greater than or equal to 0.007938 meters.

29. The device of claim 24, wherein the unit comprises a major dimension that is less than or equal to 0.0381 meters and greater than or equal to 0.03175 meters.

30. The device of claim 29 in combination with the first force coupler component, wherein the opening comprises a substantially circular opening;
wherein the substantially circular opening comprises a diameter that is less than or equal to 0.0381 meters and greater than or equal to 0.03175 meters, wherein the substantially circular opening comprises a depth that is less than or equal to 0.0254 meters and greater than or equal to 0.01905 meters.

31. The device of claim 24, wherein the unit comprises a major dimension that is less than or equal to 0.0763 meters and greater than or equal to 0.0635 meters.

32. The device of claim 31 in combination with the first force coupler component, wherein the opening comprises a substantially circular opening;
wherein the substantially circular opening comprises a diameter that is less than or equal to 0.0763 meters and greater than or equal to 0.0635 meters, wherein the substantially circular opening comprises a depth that is less than or equal to 0.0381 meters and greater than or equal to 0.0254 meters.

33. The device of claim 1, wherein one or more of the four force distribution components comprise one or more first protuberances;
wherein one or more of the one or more force coupler components comprise one or more second protuberances; and
wherein movement of the one or more force coupler components from a first force transmission position set of a plurality of third positions to a second force transmission position set of the plurality of third positions, upon operative location of the four force distribution components relative to the one or more force coupler components, serves to one or more of abut and engage a portion of one or more of the one or more first protuberances with a portion of one or more of the one or more second protuberances and promote force transmission between the four force distribution components and the one or more force coupler components.

34. The device of claim 1, wherein one or more of the four force distribution components comprise one or more first protuberances;
wherein one or more of the one or more force coupler components comprise one or more second protuberances; and
wherein movement of the one or more force coupler components from a first position set of a plurality of third positions to one or more second position sets of the plurality of third positions, upon operative location of the four force distribution components relative to the one or more force coupler components, serves to contact one or more portions of one or more of the one or more first protuberances with one or more portions of one or more of the one or more second protuberances and produce one or more audible sounds.

35. The device of claim 1, wherein one or more of the four force distribution components comprise one or more first protuberances;
wherein one or more of the one or more force coupler components comprise one or more second protuberances; and
wherein movement of the one or more force coupler components from a first position set of a plurality of third positions to one or more second position sets of the plurality of third positions, upon operative location of the four force distribution components relative to the one or more force coupler components, serves to contact one or more portions of one or more of the one or more first protuberances with one or more portions of one or more of the one or more second protuberances and produce one or more clicks.

36. The device of claim 1 in combination with the one or more force coupler components, wherein the one or more force coupler components comprise a wrench lever component;
wherein the four force distribution components comprise four gear shoe components that, upon operative location of the four gear shoe components relative to the wrench lever component, are movable among the plurality of first positions relative to the wrench lever component; and
wherein the four spreader components comprise four wedge components that are movable among the plurality of second positions relative to the four gear shoe components.

37. The device of claim 1 in combination with the one or more force coupler components, wherein the one or more force coupler components comprise a first wrench lever component that is pivotably connectable with a second wrench lever component.

38. The device of claim 1, wherein the one or more substantially flat first face portions comprise a first contactable face portion, wherein the one or more substantially flat second face portions comprise a second contactable face portion that comprises a rake that is less than or equal to forty degrees and greater than or equal to five degrees; and
wherein location of the four spreader components at one or more force transmission position sets of the plurality of second positions causes, through employment of contact of the first contactable face portion with the second contactable face portion, location of the four force distribution components at one or more force transmission position sets of the plurality of first positions.

39. The device of claim 1, wherein the one or more substantially flat first face portions comprise a first contactable face portion, wherein the one or more substantially flat second face portions comprise a second contactable face portion that comprises a rake that is approximately twelve degrees; and
wherein location of the four spreader components at one or more force transmission position sets of the plurality of second positions causes, through employment of contact of the first contactable face portion with the second contactable face portion, location of the four force distribution components at one or more force transmission position sets of the plurality of first positions.

40. The device of claim 1, wherein the force distribution component comprises a first force distribution component, wherein the four force distribution components comprise a second force distribution component and a third force distribution component, wherein the second force distribution component comprises one or more substantially flat third face portions, wherein the third force distribution component comprises one or more substantially flat fourth face portions;
wherein the spreader component comprises a first spreader component, wherein the four spreader components comprise a second spreader component and a third spreader component, wherein the second spreader component comprises one or more substantially flat fifth face portions, wherein the third spreader component comprises one or more substantially flat sixth face portions;
wherein location of the four spreader components at the one or more force transmission position sets of the plurality of second positions causes, through employment of contact of the one or more of the one or more substantially flat first face portions with the one or more of the one or more substantially flat second face portions and contact of one or more of the one or more substantially flat third face portions with one or more of the one or more substantially flat fifth face portions and contact of one or more of the one or more substantially flat fourth face portions with one or more of the one or more substantially flat sixth face portions, location of the four force distribution components at the one or more force transmission position sets of the plurality of first positions.

41. The device of claim 1, wherein the force distribution component comprises a first force distribution component, wherein the four force distribution components comprise a second force distribution component, a third force distribution component and a fourth force distribution component, wherein the second force distribution component comprises one or more substantially flat third face portions, wherein the third force distribution component comprises one or more substantially flat fourth face portions, wherein the fourth force distribution component comprises one or more substantially flat fifth face portions;
wherein the spreader component comprises a first spreader component, wherein the four spreader components comprise a second spreader component, a third spreader component and a fourth spreader component, wherein the second spreader component comprises one or more substantially flat sixth face portions, wherein the third spreader component comprises one or more substantially flat seventh face portions, wherein the fourth spreader component comprises one or more substantially flat eighth face portions;
wherein location of the four spreader components at the one or more force transmission position sets of the plurality of second positions causes, through employment of contact of the one or more of the one or more substantially flat first face portions with the one or more of the one or more substantially flat second face portions and contact of one or more of the one or more substantially flat third face portions with one or more of the one or more substantially flat sixth face portions and contact of one or more of the one or more substantially flat fourth face portions with one or more of the one or more substantially flat seventh face portions and contact of one or more of the one or more substantially flat fifth face portions with one or more of the one or more substantially flat eighth face portions, location of the four force distribution components at the one or more force transmission position sets of the plurality of first positions.

42. A device, comprising:
four force distribution components that, upon operative location of the four force distribution components relative to one or more first force coupler components, are movable among a plurality of first positions relative to the one or more first force coupler components, wherein the four force distribution components comprise a force distribution component that comprises one or more substantially flat first face portions;
four spreader components that are movable among a plurality of second positions relative to the four force distribution components, wherein the four spreader components comprise a spreader component that comprises one or more substantially flat second face portions and one or more substantially curved face portions; and
one or more second force coupler components that are movable among a plurality of third positions relative to the four spreader components;
wherein the four force distribution components, the four spreader components, and the one or more second force coupler components serve to allow one or more finite angular movements between the one or more first force coupler components and the four force distribution components, wherein one or more of the one or more finite angular movements is less than or equal to five degrees.

43. The device of claim 42, wherein location of the one or more second force coupler components at one or more force transmission position sets of the plurality of third positions causes, through employment of contact of one or more of the one or more substantially curved face portions with one or more portions of a force coupler component of the one or more second force coupler components, location of the four spreader components at one or more force transmission position sets of the plurality of second positions that causes, through employment of contact of one or more of the one or more substantially flat first face portions with one or more of the one or more substantially flat second face portions, location of the four force distribution components at one or more force transmission position sets of the plurality of first positions.

44. A device, comprising:
a plurality of force distribution components that, upon operative location of the plurality of force distribution components relative to one or more first force coupler components, are movable among a plurality of first positions relative to the one or more first force coupler components, wherein the plurality of force distribution components comprise a force distribution component that comprises one or more substantially flat first face portions;
a plurality of spreader components that are movable among a plurality of second positions relative to the plurality of force distribution components, wherein the plurality of spreader components comprise a spreader component that comprises one or more substantially flat second face portions;
one or more second force coupler components that are movable among a plurality of third positions relative to the four spreader components; and
a lever component;
wherein location of the one or more second force coupler components at one or more force transmission position sets of the plurality of third positions causes, through employment of contact among one or more portions of the spreader component and one or more portions of a force coupler component of the one or more second force coupler components, location of the plurality of spreader components at one or more force transmission position sets of the plurality of second positions;
wherein location of the plurality of spreader components at one or more force transmission position sets of the plurality of second positions causes, through employment of contact of one or more of the one or more substantially flat first face portions with one or more of the one or more substantially flat second face portions, location of the plurality of force distribution components at one or more force transmission position sets of the plurality of first positions;
wherein the plurality of force distribution components, the plurality of spreader components, and the one or more second force coupler components are one or more of operatively connectable with and disconnectable from the one or more first force coupler components as a unit;
wherein location of the lever component at an instance of a plurality of fourth positions relative to a portion of the one or more first force coupler components, upon operative location of the lever component relative to the one or more first force coupler components, serves to allow force transmission between the one or more first force coupler components and the unit based on a direction of angular rotation of the unit.

45. The device of claim 44, further comprising:
one or more detent components; and
one or more spring components, wherein a spring component of the one or more spring components is engaged with a detent component of the one or more detent components;
wherein location of the lever component at the instance of the plurality of fourth positions serves to allow the spring component to cooperate with the detent component and promote maintenance of the lever component at the instance of the plurality of fourth positions.

46. The device of claim 45, wherein the direction of angular rotation of the unit comprises a first direction of angular rotation of the unit;
wherein location of the lever component at the instance of the plurality of fourth positions causes the spring component to move a portion of the detent component into a pocket portion and allow relocation of the one or more first force coupler components based on a second direction of angular rotation of the unit substantially without force transmission between the one or more second force coupler components and the plurality of spreader components.

47. The device of claim 46, wherein a portion of the plurality of force distribution components comprises a recess that comprises a portion of the pocket portion;
wherein location of the lever component at the instance of the plurality of fourth positions serves to move a portion of the detent component into a portion of the recess and promote maintenance of the lever component at the instance of the plurality of fourth positions.

48. The device of claim 46, wherein the instance of the plurality of fourth positions comprises a first instance of the plurality of fourth positions, wherein the direction of angular rotation of the unit comprises a first direction of angular rotation of the unit, wherein the detent component comprises a first detent component, wherein the spring component comprises a first spring component, wherein the pocket portion comprises a first pocket portion;
wherein location of the lever component at a second instance of the plurality of fourth positions causes a second spring component of the one or more spring components to move a portion of a second detent component of the one or more detent components into a second pocket portion and allow relocation of the one or more first force coupler components based on the first direction of angular rotation of the unit substantially without force transmission between the one or more second force coupler components and the plurality of spreader components.

49. The device of claim 45, wherein the instance of the plurality of fourth positions comprises a first instance of the plurality of fourth positions, wherein the detent component comprises a first detent component, wherein the spring component comprises a first spring component;
wherein location of the lever component at a second instance of the plurality of fourth positions serves to allow a second spring component of the one or more spring components to cooperate with a second detent component of the one or more detent components and promote maintenance of the lever component at the second instance of the plurality of fourth positions.

50. The device of claim 44, wherein the force distribution component comprises a first force distribution component, wherein the plurality of force distribution components comprise a second force distribution component that comprises one or more substantially flat third face portions;
wherein the spreader component comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

51. The device of claim 44, wherein the force distribution component comprises one or more substantially flat third face portions;
wherein the spreader component comprises a first spreader component, wherein the plurality of spreader components comprise a second spreader component that comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

52. The device of claim 44, wherein the force distribution component comprises a first force distribution component, wherein the plurality of force distribution components comprise a second force distribution component that comprises one or more substantially flat third face portions;
wherein the spreader component comprises a first spreader component, wherein the plurality of spreader components comprise a second spreader component that comprises one or more substantially flat fourth face portions;
wherein the one or more force transmission position sets of the plurality of first positions comprise one or more first force transmission position sets of the plurality of first positions, wherein the one or more force transmission position sets of the plurality of second positions comprise one or more first force transmission position sets of the plurality of second positions;
wherein location of the plurality of spreader components at one or more second force transmission position sets of the plurality of second positions causes, through employment of contact of one or more of the one or more substantially flat third face portions with one or more of the one or more substantially flat fourth face portions, location of the plurality of force distribution components at one or more second force transmission position sets of the plurality of first positions.

53. The device of claim 44, wherein one or more of the one or more portions of the spreader component comprise one or more substantially curved face portions of the spreader component;
wherein location of the one or more second force coupler components at one or more force transmission position sets of the plurality of third positions causes, through employment of camming contact among one or more of the one or more substantially curved face portions and one or more portions of a force coupler component of the one or more second force coupler components, location of the plurality of spreader components at one or more force transmission position sets of the plurality of second positions.

54. The device of claim 53, wherein the plurality of spreader components comprise a plurality of wedge components, wherein the spreader component comprises a wedge component of the plurality of wedge components; and
wherein the one or more second force coupler components comprise a wrench central pivot component that is operatively movable among the plurality of third positions relative to the plurality of wedge components.

55. The device of claim 44, wherein a pivot of one or more of the one or more second force coupler components from a first instance of the plurality of third positions to a second instance of the plurality of third positions, upon operative location of the plurality of force distribution components relative to the one or more first force coupler components, serves to press the plurality of spreader components against the plurality of force distribution components and cause the plurality of force distribution components to press against the one or more first force coupler components.

56. The device of claim 44, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to five degrees.

57. The device of claim 44, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to four degrees.

58. The device of claim 44, wherein the plurality of force distribution components, the plurality of spreader components, and the one or more second force coupler components serve to allow one or more finite angular movements between the one or more first force coupler components and the plurality of force distribution components; and
wherein one or more of the one or more finite angular movements is less than or equal to three degrees.

59. The device of claim 44, wherein one or more of the plurality of force distribution components comprise one or more first protuberances;
wherein one or more of the one or more first force coupler components comprise one or more second protuberances; and
wherein movement of the one or more first force coupler components from a first force transmission position set of a plurality of fifth positions to a second force transmission position set of the plurality of fifth positions, upon operative location of the plurality of force distribution components relative to the one or more first force coupler components, serves to one or more of abut and engage a portion of one or more of the one or more first protuberances with a portion of one or more of the one or more second protuberances and promote force transmission between the plurality of force distribution components and the one or more first force coupler components.

60. The device of claim 44, wherein one or more of the plurality of force distribution components comprise one or more first protuberances;
wherein one or more of the one or more first force coupler components comprise one or more second protuberances; and
wherein movement of the one or more first force coupler components from a first position set of a plurality of fifth positions to one or more second position sets of the plurality of fifth positions, upon operative location of the plurality of force distribution components relative to the one or more first force coupler components, serves to contact one or more portions of one or more of the one or more first protuberances with one or more portions of one or more of the one or more second protuberances and produce one or more audible sounds.

61. The device of claim 44, wherein one or more of the plurality of force distribution components comprise one or more first protuberances;
wherein one or more of the one or more first force coupler components comprise one or more second protuberances; and
wherein movement of the one or more first force coupler components from a first position set of a plurality of fifth positions to one or more second position sets of the plurality of fifth positions, upon operative location of the plurality of force distribution components relative to the one or more first force coupler components, serves to contact one or more portions of one or more of the one or more first protuberances with one or more portions of one or more of the one or more second protuberances and produce one or more clicks.

62. The device of claim 44 in combination with the one or more first force coupler components, wherein the one or more first force coupler components comprise a wrench lever component;
wherein the plurality of force distribution components comprise a plurality of gear shoe components that, upon operative location of the plurality of gear shoe components relative to the wrench lever component, are movable among the plurality of first positions relative to the wrench lever component; and
wherein the plurality of spreader components comprise a plurality of wedge components that are movable among the plurality of second positions relative to the plurality of gear shoe components.

63. The device of claim 44 in combination with the one or more first force coupler components, wherein the one or more first force coupler components comprise a first wrench lever component that is pivotably connectable with a second wrench lever component.

64. The device of claim 44, wherein the one or more substantially flat first face portions comprise a first contactable face portion, wherein the one or more substantially flat second face portions comprise a second contactable face portion that comprises a rake that is less than or equal to forty degrees and greater than or equal to five degrees; and
wherein location of the plurality of spreader components at one or more force transmission position sets of the plurality of second positions causes, through employment of contact of the first contactable face portion with the second contactable face portion, location of the plurality of force distribution components at one or more force transmission position sets of the plurality of first positions.

65. The device of claim 44, wherein the one or more substantially flat first face portions comprise a first contactable face portion, wherein the one or more substantially flat second face portions comprise a second contactable face portion that comprises a rake that is approximately twelve degrees; and
wherein location of the plurality of spreader components at one or more force transmission position sets of the plurality of second positions causes, through employment of contact of the first contactable face portion with the second contactable face portion, location of the plurality of force distribution components at one or more force transmission position sets of the plurality of first positions.

66. The device of claim 44, wherein the force distribution component comprises a first force distribution component, wherein the plurality of force distribution components comprise a second force distribution component that comprises one or more substantially flat third face portions;
wherein the spreader component comprises a first spreader component, wherein the plurality of spreader components comprise a second spreader component that comprises one or more substantially flat fourth face portions;
wherein location of the plurality of spreader components at one or more force transmission position sets of the plurality of second positions causes, through employment of contact of one or more of the one or more substantially flat first face portions with one or more of the one or more substantially flat second face portions and contact of one or more of the one or more substantially flat third face portions with one or more of the one or more substantially flat fourth face portions, location of the plurality of force distribution components at one or more force transmission position sets of the plurality of first positions.

67. The device of claim 44, wherein the one or more first force coupler components comprise a first force coupler component, wherein the first force coupler component comprises an opening;
wherein the plurality of force distribution components, the plurality of spreader components, and the one or more second force coupler components are one or more of operatively locatable at least partially within and operatively disconnectable from the opening of the first force coupler component as the unit.

68. The device of claim 67, wherein the unit comprises a major dimension that is less than or equal to 0.03175 meters and greater than or equal to 0.01905 meters.

69. The device of claim 68 in combination with the first force coupler component, wherein the opening comprises a substantially circular opening;
wherein the substantially circular opening comprises a diameter that is less than or equal to 0.03175 meters and greater than or equal to 0.01905 meters, wherein the substantially circular opening comprises a depth that is less than or equal to 0.01905 meters and greater than or equal to 0.0127 meters.

70. The device of claim 67, wherein the unit comprises a major dimension that is less than or equal to 0.01905 meters and greater than or equal to 0.0127 meters.

71. The device of claim 70 in combination with the first force coupler component, wherein the opening comprises a substantially circular opening;
wherein the substantially circular opening comprises a diameter that is less than or equal to 0.01905 meters and greater than or equal to 0.0127 meters, wherein the substantially circular opening comprises a depth that is less than or equal to 0.009525 meters and greater than or equal to 0.007938 meters.

72. The device of claim 67, wherein the unit comprises a major dimension that is less than or equal to 0.0381 meters and greater than or equal to 0.03175 meters.

73. The device of claim 72 in combination with the first force coupler component, wherein the opening comprises a substantially circular opening;
wherein the substantially circular opening comprises a diameter that is less than or equal to 0.0381 meters and greater than or equal to 0.03175 meters, wherein the substantially circular opening comprises a depth that is less than or equal to 0.0254 meters and greater than or equal to 0.01905 meters.

74. The device of claim 67, wherein the unit comprises a major dimension that is less than or equal to 0.0763 meters and greater than or equal to 0.0635 meters.

75. The device of claim 74 in combination with the first force coupler component, wherein the opening comprises a substantially circular opening;
wherein the substantially circular opening comprises a diameter that is less than or equal to 0.0763 meters and greater than or equal to 0.0635 meters, wherein the substantially circular opening comprises a depth that is less than or equal to 0.0381 meters and greater than or equal to 0.0254 meters.

76. The device of claim 44, wherein the plurality of force distribution components comprise four force distribution components, wherein the plurality of spreader components comprise four spreader components;
wherein the four force distribution components, upon operative location of the four force distribution components relative to the one or more force coupler components, are movable among the plurality of first positions relative to the one or more force coupler components, wherein the four force distribution components comprise the force distribution component that comprises the one or more substantially flat first face portions;
wherein the four spreader components are movable among the plurality of second positions relative to the four force distribution components, wherein the four spreader components comprise the spreader component that comprises the one or more substantially flat second face portions;
wherein location of the four spreader components at the one or more force transmission position sets of the plurality of second positions causes, through employment of contact of the one or more of the one or more substantially flat first face portions with the one or more of the one or more substantially flat second face portions, location of the four force distribution components at the one or more force transmission position sets of the plurality of first positions.
